(19) United States
(12) Patent Application Publication
(10) Pub. No.: US 2025/0371272 A1
(43) Pub. Date: Dec. 4, 2025

(54) MODIFIED LARGE LANGUAGE MODEL ARCHITECTURE WITH SPAN-LEVEL ATTENTION MECHANISM FOR CONVERSION OF NATURAL LANGUAGE TEXT TO STRUCTURED KNOWLEDGE GRAPH

(71) Applicant: Optum, Inc., Minnetonka, MN (US)

(72) Inventors: Carlos W. MORATO, Sammamish, WA (US); Zahra RAJABI, Vienna, VA (US); Sanjay Kumar SINGH, Karnataka (IN); Zhili YANG, Chesterbrook, PA (US)

(21) Appl. No.: 18/733,197

(22) Filed: Jun. 4, 2024

(51) Int. Cl. G06F 40/30; G06F 40/284

(52) U.S. Cl. CPC G06F 40/30; G06F 40/284

(57) ABSTRACT

Various embodiments of the present disclosure provide machine learning architectures and data processing techniques for improving computer-based text comprehension. The techniques may include identifying a plurality of data entity tokens from a target section of a multi-section natural language document and generating, using an embedding layer of a semantic chunking model, a text span embedding for a text span of the target section. The techniques may include leveraging the semantic chunking model to generate an attended span representation for the text span based on the text span embedding and the plurality of data entity tokens. The techniques may include identifying an entity topic that corresponds to the text span based on the attended span representation and, responsive to an identification of the entity topic, generating a subgraph data object for a knowledge graph using the text span.

### BACKGROUND

Various embodiments of the present disclosure address technical challenges related to large language models (LLMs) and data conversion techniques. Traditional LLMs are subject to a number of technical challenges that limit their use for text comprehension of complex documents, including multi-section natural language documents, due to their length and hierarchical structures. These technical challenges constrain the use of LLMs to certain computing tasks. For example, while LLMs may be incorporated to certain data conversion tasks, they may fail to interpret deep semantic relationships in text that are necessary for reliably converting information from complex natural language text into structured representations.

Various embodiments of the present disclosure make important contributions to traditional LLMs by addressing these technical challenges, among others.

### BRIEF SUMMARY

Various embodiments of the present disclosure provide machine learning and data processing techniques that improve traditional computer-based text comprehension technology, such as those that leverage LLMs. To do so, some embodiments of the present disclosure provide a multi-stage data conversion technique for converting complex unstructured textual data into a structured knowledge graph that is interpretable for downstream computing tasks. The multi-stage data conversion techniques leverage a new modified LLM architecture, a semantic chunking model, to leverage LLM capabilities for tasks previously outside the realm of LLMs. For example, while traditional LLMs excel at extracting and understanding data from unstructured text, they fail to account for the semantic structure of the text when interpreting the data. This, and other technical deficiencies, prevents traditional LMMs from accurately detecting and interpreting semantic relationships between segments of text distributed across multiple disparate sections of a multi-section natural language document layout. Some techniques of the present disclosure provide new model architectures, and data processing pipelines that leverage the new model architectures, to specifically address these technical deficiencies inherent in traditional LLMs. This, in turn, enables an improved data processing pipeline that directly addresses technical challenges within the realm of text comprehension technology.

In some embodiments, a computer-implemented method includes identifying, by one or more processors and using a natural language understanding (NLU) model, a plurality of data entity tokens from a target section of a multi-section natural language document; generating, by the one or more processors and using an embedding layer of a semantic chunking model, a text span embedding for a text span of the target section; generating, by the one or more processors and using a span attention layer of the semantic chunking model, a plurality of token-level span attention vectors for the plurality of data entity tokens based on the text span; generating, by the one or more processors, an attended span representation for the text span based on the text span embedding and the plurality of token-level span attention vectors; identifying, by the one or more processors and using a span classification layer of the semantic chunking model, an entity topic that corresponds to the text span based on the attended span representation; and responsive to an identification of the entity topic, generating, by the one or more processors, a subgraph data object for a knowledge graph using the text span.

In some embodiments, a computing system includes memory and one or more processors communicatively coupled to the memory, the one or more processors are configured to identify, using a natural language understanding (NLU) model, a plurality of data entity tokens from a target section of a multi-section natural language document; generate, using an embedding layer of a semantic chunking model, a text span embedding for a text span of the target section; generate, using a span attention layer of the semantic chunking model, a plurality of token-level span attention vectors for the plurality of data entity tokens based on the text span; generate an attended span representation for the text span based on the text span embedding and the plurality of token-level span attention vectors; identify, using a span classification layer of the semantic chunking model, an entity topic that corresponds to the text span based on the attended span representation; and responsive to an identification of the entity topic, generate a subgraph data object for a knowledge graph using the text span.

In some embodiments, one or more non-transitory computer-readable storage media include instructions that, when executed by one or more processors, cause the one or more processors to identify, using a natural language understanding (NLU) model, a plurality of data entity tokens from a target section of a multi-section natural language document; generate, using an embedding layer of a semantic chunking model, a text span embedding for a text span of the target section; generate, using a span attention layer of the semantic chunking model, a plurality of token-level span attention vectors for the plurality of data entity tokens based on the text span; generate an attended span representation for the text span based on the text span embedding and the plurality of token-level span attention vectors; identify, using a span classification layer of the semantic chunking model, an entity topic that corresponds to the text span based on the attended span representation; and responsive to an identification of the entity topic, generate a subgraph data object for a knowledge graph using the text span.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for converting complex, unstructured documents to a structured knowledge graph in accordance with some embodiments of the present disclosure.

FIG. 5 is an operational example of a semantic chunking techniques that leverages a modified large language model architecture in accordance with some embodiments of the present disclosure.

FIG. 6 is an operational example of a knowledge graph for a clinical domain in accordance with some embodiments of the present disclosure.

FIG. 7 is a flowchart diagram of an example process for converting complex, unstructured documents to a structured knowledge graph in accordance with some embodiments of the present disclosure.

FIG. 8 is a flowchart diagram of an example process for leveraging a structure knowledge for improve query handling operations in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

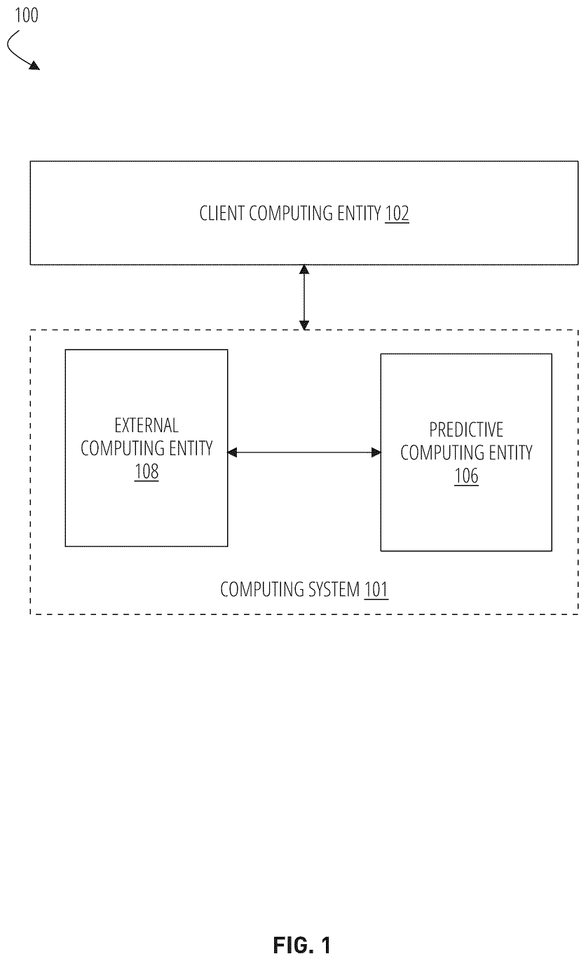

FIG. 1 provides an example overview of an architecture 100 in accordance with some embodiments of the present disclosure. The architecture 100 includes a computing system 101 configured to receive request, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to (i) generate one or more embeddings, classification, relevancy score, etc., (ii) extract one or more features from data, (iii) construct data structures from complex text data, and/or the like. The models may form a machine learning pipeline that may be configured to automatically generate and/or update portions of a knowledge graph, leverage the knowledge graph to handle a query, and/or the like. Some techniques of the present disclosure may adapt traditional models to more complex data than previously interpretable using such models.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to modify, augment, and/or leverage a knowledge graph, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., embedding techniques, query handling techniques, graph construction techniques, semantic chunking techniques, and/or the like) described herein. The external computing entities 108, for example, may include and/or be associated with one or more entities that may be configured to receive, transmit, store, manage, and/or facilitate datasets, such as the knowledge graph, a data store of multi-section natural language documents, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

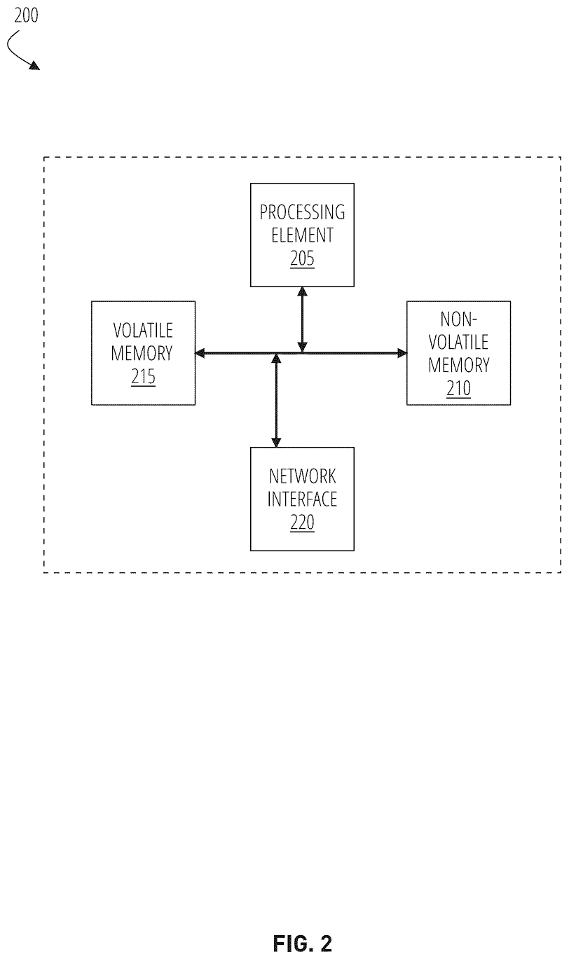

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

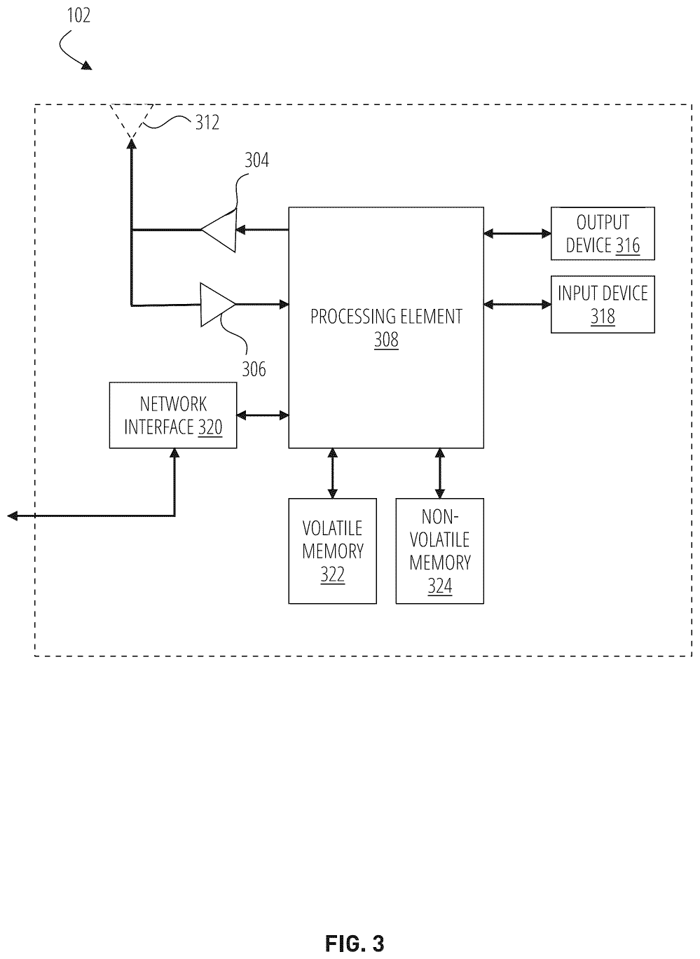

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “multi-section natural language document” refers to a data structure that describes textual information formatted according to one or more hierarchical sections. A multi-section natural language document, for example, may include a plurality of sections arranged according to one or more hierarchical relationships (e.g., subsection, etc.). A multi-section natural language document may express one or more entity topics across one or more of the plurality of sections. In some examples, a multi-section natural language document may include textual information for each of a plurality of entity topics. The textual information may include one or more systematically developed statements. By way of example, in a clinical domain, a multi-section natural language document may include clinical practice guidelines with a plurality of systematically developed statements to assist practitioner and patient decisions about appropriate health care for specific clinical circumstances. The statements, for example, may contain recommendations that are based on evidence from a rigorous systematic review and synthesis of the published medical literature.

In some embodiments, a multi-section natural language document is a living document that is dynamically updated based on real world circumstances. A multi-section natural language document, for example, may include summaries of scientific evidence supporting one or more current recommendations that may change as the scientific evidence develops within a field. As an example, using the clinical domain, clinical practice guidelines may summarize medical knowledge, weigh the benefits and harms of diagnostic procedures and treatments, give specific recommendations based on this information, and must be updated based on based on changes to the summarized information.

A multi-section natural language document is created for human use without consideration of the technical challenges prevalent in computer interpretation of data. For this reason, there are several challenges for distilling computer interpretable rules from a multi-section natural language document, including complexities due to document lengths, frequency of updates, and the unstructured placement of different rule features that cannot be automatically consumed and analyzed by the computing systems.

In some embodiments, the above challenges are addressed using a semantic chunking model and semantic chunking techniques. The semantic chunking techniques may leverage contextual chunking of a set of multi-section natural language documents to divide the set of multi-section natural language documents into candidate sections. In some examples, each candidate section may include one or more text spans (e.g., a set of guidelines associated with the context of a particular section, etc.) that may be individually processed and then compared against other text spans to create structured rules from the multi-section natural language document.

In some examples, a multi-section natural language document may be processed to extract one or more hierarchical text attributes and/or determine a topic relevance of each candidate section (and/or text span thereof) of the multi-section natural language document. Both the hierarchy and topic relevance of each section may be preserved and leveraged by a semantic chunking model to perform topic-based guideline abstraction by combining subsection extraction and topic extraction. This allows traditionally indecipherable multi-section natural language documents to be processed and converted to meaningful sections of span representations.

In some embodiments, the term “hierarchical text attribute” refers to a data structure that describes a format characteristic of a multi-section natural language document. For example, a multi-section natural language document may be consumed, and a hierarchical organization of the document may be captured as a plurality of hierarchical text attributes. The hierarchical text attributes, for example, may identify one or more section identifiers, such as titles, subtitles, section headings, and/or the like, and/or any other structural characteristic of a multi-section natural language document. In some examples, one or more document insights may be derived based on the hierarchical text attributes. By way of example, natural language understanding (NLU) techniques may be leveraged to extract target insights, such as one or more data entity tokens, entity topics, and/or the like, from the hierarchical text attributes.

In some embodiments, the term “target section” refers to a data structure that describes a portion of text within a natural language document. A target section, for example, may include a section of text from a plurality of candidate sections defined by the formatting of a multi-section natural language document. A target section may include one or more paragraphs, bullet points, lists, and/or the like within and/or associated with a section identifier. By way of example, a target section may include a section title, such as “Diagnosis Guidelines Adults,” “Assess Risk Assessment,” and/or the like for a clinical guideline document. In some examples, a target section may be associated with one or more entity topics.

In some embodiments, the term “entity topic” refers to a data structure that describes a set of data entities with a unique representation and semantic meaning in text. An entity topic, for example, may include a plurality of data entity tokens that are representative of a unique concept expressed by a portion of a multi-section natural language document. In some examples, a plurality of entity topics may be extracted from a multi-section natural language document. Example entity topics for a clinical domain, for example, may be related to diseases, cardiovascular, treatments, conditions, symptoms, side effects, guideline, and/or the like. In some examples, the plurality of entity topics extracted may be referred to herein as “T.” Each topic may be represented by a collection of words and referred to a ti.

In some embodiments, the term “text span” refers to a data structure that describes a segment of text (e.g., a sequence of alphanumeric characters, etc.) from a target section of a multi-section natural language document. For example, a multi-section natural language document may be split into a plurality of pieces of texts (e.g., text spans) with a goal of avoiding blind document chunks. Each text span may be individually processed with the context of a section from which it was extracted to remove unrelated, out of scope pieces of text from the multi-section natural language document and focus on relevant pieces of text that encapsulate an otherwise long document in a collection of semantically connected pieces of texts.

In some examples, a text span may include one or more data entity tokens connected by entity relationship tokens. The entity relationship tokens may semantically connect at least a pair of data entity tokens to form a token-to-token relationship that defines a condition with respect to an entity topic. By way of example, in a clinical domain, text spans may include:

$$[ ( LDL - C \geq 5 mmol / L ) OR ( ApoB \geq 1.45 g / L ) OR ( non - HDL - C \geq 5.8 mmol / L ) OR ( documented familial hypercholestrolemia ) ] ,$$

In some examples, a text span may include a reference to another, sub-text span, such as the documented familiar hypercholesteremia text span in the above example, which may be represented as:

$$( ( LDL - C \geq 5 mmol / L ) OR ( ApoB \geq 1.45 g / L ) OR ( non - HDL - C \geq 5.8 mmol / L ) )$$

Using the techniques of the present disclosure, a plurality of text spans may be extracted from a multi-section natural language document and processed by a semantic chunking model to assign each text span to an entity topic. In some embodiments, one or more text spans assigned to an entity topic may be processed to extract a plurality of tuples for the entity topic using the semantic chunking model.

In some embodiments, the term “entity relationship token” refers to a data entity that describes a textual term (e.g., a sequence of alphanumeric characters, mathematical symbols, etc.) that defines a unique relationship between two data entity tokens. An entity relationship, for example, may include a factor edge indicative of a relationship between two data entity tokens that may be expressed as a conditional statement, such as a mathematical operator (e.g., ≥, =, etc.). In addition, or alternatively, an entity relationship token may include span edge indicative of a relationship between two conditional statements relative to a topic. A span edge, for example, may be expressed as a joining condition (e.g., AND, OR, etc.) that defines a combination of conditional statements to achieve one or more results with respect to an entity topic.

In some embodiments, the term “data entity token” refers to a data entity that describes a textual term (e.g., a sequence of alphanumeric characters, etc.) that has unique representation and semantic meaning in text. A data entity token, for example, may include a term that is recognized by a large language model (e.g., a learned entity from a vocabulary, etc.). In some examples, a data entity token may be domain specific. For instance, data entity tokens may include disease types (e.g., Dyslipidemia, Disease, etc.) for a clinical domain.

In some embodiments, the term “token vector” refers to a vectorized representation of a data entity token. In some examples, a token vector may include an input to a semantic chunking model that encodes a data entity token from a target section as well as hierarchical text attributes associated with the data entity token. For example, a semantic chunking model may receive a sequence of token vectors tᵢ . . . , . . . , . . . tⱼ of a target section. Each of the token vectors may be embedded as a sequence of high dimensional vectors representing data entity tokens of one or more entity topics expressed by the target section.

In some examples, the sequence of token vectors may be extracted from one or more relevant sentences of the target section. For instance, the sequence of token vectors may be extracted from Ø_{sentence}≈Ø_{Threshold}, where Ø_{sentence} includes sentences with a relevancy score that exceed a tunable threshold relevance (e.g., 0.8, 0.9, etc.). The resulting sequence of token vectors may correspond to a set of data entity tokens {eⱼ, eₖ, Ø}∈E_{E} ranging in a topic (set of entities in a section j) of a document (k) from relevant sentences Ø). In some examples, the relevancy score for a sentence may be generated by a supervised machine learning model.

In some examples, a relevancy of a sentence may be based on the following document relevance criteria: (a) highly relevant: leading section associated with topics mentions topic-specific arguments, reports (evidence); (b) somewhat relevant: leading section uses mentions from identified topics in its leading section to substantiate central topic in a section, (c) not relevant: Document section is on topic, information contained in document may only help as a secondary source, nice to have information; and (d) off topic: sections in document is off topic. In some examples, the context of a multi-section natural language document may be synthesized by collecting a set of “N” topics and associated candidate sections representing specific guidelines and sampling relationships between topics and sections. The relationships may be recorded as contextual edges “E” between entity topics and candidate sections in a multi-section natural language document, contextual_{edges}=[(t₁, r₁s₁) . . . (tᵢ, rₖsⱼ)]. Once the contextual edges are defined, topics tⱼ and tⱼ may be selected from related sections to compute weights of their sentence relevance Ø_{sentence}.

In some embodiments, the term “sentence relevancy prediction” refers to a determination of whether a candidate sentence of a target section is relevant for a semantic chunking process. In some examples, the sentence relevancy prediction may be determined based on a comparison between a relevancy score output by a supervised machine learning model and a tunable relevancy threshold.

In some embodiments, the term “supervised machine learning model” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). The supervised machine learning model may include any type of model configured, trained, and/or the like to process input text and, in response to the input text, output a relevancy prediction for the input text. In some examples, the supervised machine learning model may include a neural network architecture that is trained, using backpropagation of errors, to optimize a classification loss. The supervised machine learning model may be trained using a plurality of training data entries. Each training data entry may include a relevancy label (e.g., binary, relevancy type label, such as highly relevant, somewhat relevant, not relevant, off topic, etc.), training text, and one or more training features, such a training hierarchical text attribute.

In some embodiments, the term “semantic chunking model” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). The semantic chunking model may include any type of model configured, trained, and/or the like to process input text and, in response to the input text, output one or more textual insights, such as classifications and/or extracted components from the text based on the classifications. In some examples, the semantic chunking model may include a modified LLM architecture with a plurality of layers specially designed for a text classification process. Each of the layers of the modified LLM may include one or more classification, embedding, and/or attending layers constructed using any type of model architecture, including transformers, neural networks, decision trees, and/or the like.

In some embodiments, the semantic chunking model may include a generative pretrained transformer that is modified with a span self-attention mechanism to generate a plurality of token-level span attention vectors with respect to a text span embedding of a text span extracted from a target section of a multi-section natural language document. The semantic chunking model may implement a workflow to construct dynamic edges and establish relationships within sections of a multi-section natural language document. The semantic chunking model architecture may leverage the text span embeddings, token-level span attention vectors, and span classification layer to filter out valid text spans from candidate sections from a set of multi-section natural language documents for chunking. The chunking process may be repeated for all possible spans_{j,k} up to a given length in a target section for each section across each of the set of multi-section natural language documents to generate a knowledge graph derived from the set of multi-section natural language documents. In this manner, a semantic chunking model, as described herein, may leverage the capabilities of LLMs with updated design to build a knowledge management system to extract rule-based structured guidance from unstructured textual guidelines.

In some embodiments, the semantic chunking model includes a machine learning pipeline with a plurality of layers collectively configured to build a knowledge graph from text spans extracted across a plurality of multi-section natural language documents. The plurality of layers, for example, may include (a) an embedding layer configured to generate a text span embedding for a text span, (b) a transformer layer configured to generate a token-level span embeddings for input data entity tokens and a document classification vectors for a document corresponding to the input data entity tokens, (c) a span attention layer configured to attend the token-level span embeddings based on a particular text span to generate a token-level span attention vectors, (d) a span classification layer configured to generate an attended span representation and assign a text span to an entity topic and/or mutually exclusive topic type, (e) a feature extraction layer configured to extract entity factor nodes and entity factor edges from valid text spans, (f) an edge pruning layer configured to remove nodes and edges in accordance with edge pruning criteria, among other layers.

In some embodiments, the term “embedding layer” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). An embedding layer, for example, may include a machine learning layer of the semantic chunking model. The embedding layer may include an encoder-only layer, including one or more feed-forward neural networks, and/or the like. The embedding layer may be configured to generate a text span embedding from an input text span. In some examples, the embedding layer may include a pretrained encoder-only model, such as bidirectional encoder representations from transformers (BERT) model.

In some embodiments, the term “text span embedding” refers to a vectorized representation of a text span. A text span embedding, for example, may include a token-level embedding of a plurality of data entity tokens of the text span.

In some embodiments, the term “transformer layer” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). A transformer layer, for example, may include a machine learning layer of the semantic chunking model. In some examples, the transformer layer may include a bidirectional recurrent neural network (BiRNN) architecture. The transformer layer may be configured to generate a plurality of token-level span embeddings for a sequence of input token vectors. In addition, or alternatively, the transformer layer may be configured to generate a document classification vector.

In some embodiments, the term “span attention layer” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). A span attention layer, for example, may include a machine learning attention layer of the semantic chunking model. In some examples, one or more span attention layers may be appended to the transformer layer. The span attention layers may receive token-level span embeddings and perform one or more self-attention operations for attending the token-level span embeddings with respect to an input text span. The resulting token-level span attention vectors may be output for each input text span and a set of input data entity tokens.

In some embodiments, the term “token-level span attention vector” refers to a weighted vectorized representation of a data entity token that is weighted based on a correlation with an input text span.

In some embodiments, the term “document classification vector” refers to a weighted vectorized representation of a multi-section natural language document, and/or portion thereof, that corresponds to a particular text span. A document classification vector, for example, may include a classify token (CLS) designed to represent information from complete text.

In some embodiments, the term “span classification layer” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). A span classification layer, for example, may include a machine learning layer of the semantic chunking model. In some examples, the span classification layer may generate and then leverage an attended span representation for each of a plurality of text spans to classify each individual text span as (a) valid (e.g., relevant to at least one topic, etc.) or invalid (e.g., irrelevant to all entity topics, etc.) and (b) into mutually exclusive types. In some examples, only valid text spans are passed to a subsequent layer of the semantic chunking model to be processed further for extraction of relationships between factors and factor-edges. In this manner, the span classification layer may remove irrelevant portions of sections being considered as well as bring in any left-out sections from different sections of a multi-section natural language document and/or a set of multi-section natural language documents. The span classification layer may generate one or more span classification based on one or more vector grouping techniques (e.g., nearest neighbors search, etc.) and/or vector comparison scores (e.g., cosine similarity, etc.).

In some embodiments, the term “attended span representation” refers to a weighted vectorized representation of a text span. An attended span representation, for example, may include an aggregation of a text span embedding with a plurality of token-level span attention vectors. For instance, attended span representations, spans_{j,k}, may be generated by concatenating together the attention representations of span and span embeddings (covering all possible spans). Each valid span of length l looks up different vector of learned parameters associated with a mutually exclusive category for a particular entity topic.

In some embodiments, the term “topic embedding” refers to a vectorized representation of an entity topic. A topic embedding, for example, may include a token-level embedding of a plurality of data entity tokens of the entity topic.

In some embodiments, the term “type classification prediction” refers to an output of a span classification layer for a text span. A type classification prediction may be indicative of a validation of a text span (e.g., that the text span is relevant to at least one entity topic). In addition, or alternatively, the type classification prediction may be indicative of a mutually exclusive topic type corresponding to the text span.

In some embodiments, the term “mutually exclusive topic type” refers to a type of type classification prediction. A mutually exclusive topic type may include a grouping identifier to distinguish between different groups of text spans related to a single entity topic. By way of example, different text spans in the context of Dyslipidemia may be described as a Disease, Symptom, Condition, Treatment, Demography, Side Effect, Risk, and/or other mutually exclusive topic types.

In some embodiments, the term “feature extraction layer” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). A feature extraction layer, for example, may include a natural language processing (NLP) layer of the semantic chunking model that is configured to extract data entity tokens and entity relationship tokens from a valid text span. As described herein, the feature extraction layer may generate, modify, and/or remove nodes and/or edges from a subgraph data object in accordance with one or more data entity tokens (e.g., attributes Aᵣ) and/or entity relationship tokens extracted from the valid text span. By way of example, the feature extraction layer may perform the following operations:

```
$Input : span {s}_{i} extracted from set of documents {\sum }_{k = 0}^{n} {d}_{k} with entities {E}_{ε} ∈ {t}_{i}$
Initialization
for span s in sᵢ do
    for topics t in tᵢ, tᵢ ∈ s do
      for attributes Aᵣ in span s in span section ss of topic t do
        Insert f as factor and association of factor as factor_{edges} in node N such that f ∈ Aᵣ
      if length of span representation is < threshold then
        Insert node nᵢ in span representation Sᵣ as subnode of topic t
    while span_{length} ≤ permissible_{pathLength} do
      path = path + nᵢ where nᵢ (factor, factor_{edges})
end
Output: Span Representation (Contextual Semantic Chunking + Relationship)
```

By way of example, factors and factor edges may be modified using the following semantic operations: factor insertion, factor deletion, factor substitution, factor edges insertion, factor edges deletion, factor edges substitution where association of disjoint factors is achieved using co-span distance from span section and associated entity topics.

In some embodiments, the term “subgraph data object” refers to a portion of a knowledge graph that corresponds to a text span from a multi-section natural language document. A subgraph data object, for example, may include a plurality of entity factor nodes and entity factor edges extracted from a particular text span of a target section within a multi-section natural language document of a plurality of multi-section natural language documents.

In some embodiments, the term “knowledge graph” refers to a data structure that describes a plurality of linked concepts from a plurality of multi-section natural language documents. The knowledge graph, for example, may include a graph-based data structure that is generated and continuously modified for a particular knowledge domain. The knowledge graph may be continuously modified, using some of the techniques of the present disclosure, using extracted data entity and entity topics for a set of section text spans using span representations, as described herein.

In some embodiments, the term “entity factor node” refers to a component of a knowledge graph. An entity factor node may describe a relevant factor for an entity topic. The relevant factor, for example, may correspond to a data entity token of a text span.

In some embodiments, the term “entity factor edge” refers to a component of a knowledge graph. An entity factor edge may describe a relevant condition for an entity topic. The relevant condition, for example, may correspond to an entity relationship token of a text span.

In some embodiments, the term “edge pruning layer” refers to a data structure that describes parameters, hyper-parameters, and/or defined operations of a rules-based and/or machine learning model (e.g., model including at least one of one or more rule-based layers, one or more layers that depend on trained parameters, coefficients, and/or the like). An edge pruning layer, for example, may include a filtering layer of the semantic chunking model. An edge pruner helps to analyze any inconsistent relationships that may be optionally discarded in case either model confidence is low, or it is found to be inconsistent/contrast as compared to available guidelines.

In some embodiments, the term “edge pruning criteria” refers to a data structure that describes one or more edge restrictions for a knowledge graph. The edge pruning criteria may be tunable based on the knowledge domain. In some examples, the edge pruning criteria may establish a confidence threshold, a compliance with one or more ground truth rulesets, and/or the like.

In some embodiments, the term “query” refers to a data structure that describes a request to a knowledge graph. A query, for example, may include a textual prompt for a structured rule for a specific scenario. In response to the query, an inference may be performed over the knowledge graph to extract “tree-based rules” from the knowledge graph. In some examples, using a clinical example, the extracted rules may resemble patient questionnaires and/or the like. In some examples, a query is processed by extracting one or more sub-graph data objects from the knowledge graph given each question that maps to each criterion. The sub-graph data objects may be called Tree-based Decision Path (TPD). An inference may be performed on the knowledge graph, and rules may be validated by extracting the TDP subgraph by a depth-first search traversal algorithm.

### IV. OVERVIEW

Various embodiments of the present disclosure provide machine learning architectures and data processing techniques that improve computer-based text comprehension with respect to complex textual data. To do so, some embodiments of the present disclosure provide a multi-stage data conversion technique for converting complex unstructured textual data into a structured knowledge graph that is interpretable for downstream computing tasks. The multi-stage data conversion techniques leverage a new modified LLM architecture, a semantic chunking model, to leverage LLM capabilities for task previously outside the realm of LLMs. For example, while traditional LLMs excel at extracting and understanding data from unstructured text, they fail to account for the semantic structure of the text when interpreting the data. This, and other technical deficiencies, prevents traditional LMMs from accurately detecting and interpreting semantic relationships between segments of text distributed across multiple disparate sections of a multi-section natural language document layout. Some techniques of the present disclosure provide new model architectures, and data processing pipelines that leverage the new model architectures, to specifically address these technical deficiencies inherent in traditional LLMs.

Some embodiments of the present disclosure provide new model architectures to improve the performance of traditional LLMs with respect to rule extraction from a plurality of multi-section natural language documents. The new model architecture may modify a traditional LLM architecture with a span attention and classification mechanism configured to (i) embed a plurality of text segments from a section within a document into a common feature space and (ii) classify the text segments into mutually exclusive topic categories. By doing so, the new model architecture may filter out irrelevant text segments and connect relevant text segments from across a plurality of different sections and documents. This, in turn, enables improved detection of the semantic connection between text within a document that allows for downstream data conversion tasks previously hindered by conventional LLM technology.

Some embodiments of the present disclosure leverage new model architectures in new data processing pipelines to automate traditionally subjective data conversion techniques. As described herein, complex, multi-section natural language documents present several technical challenges to machine learning-based data comprehension due to their length and the formatting nuances that are subjective in nature and difficult to logically interpret. The data processing pipelines of the present disclosure leverage new model architectures to filter, focus, and connect semantically relevant features from a multi-segment natural language document. These connections may be extracted, using feature extraction techniques described herein, and leveraged to convert traditionally non-interpretable natural language text into a structured, knowledge graph. By doing so, data insights may be automatically extracted from uninterpretable data structures and stored in new data structures tailored to downstream computing tasks, such as intelligent query-based structured ruleset generation as provided herein.

Examples of technologically advantageous embodiments of the present disclosure include: (i) modified LLM architectures that improve upon traditional LLM models, (ii) data processing pipelines for converting complex text formats to structured knowledge graphs, (iii) query handling techniques for automatically generating structured rulesets originating from complex text formats, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to machine learning and data conversion technology. In particular, systems and methods are disclosed herein that implement modified LLM architectures and data processing pipelines to improve machine learning model performance with respect to text interpretation and data conversion tasks. By doing so, machine learning models may be improved to expand the applicability of LLMs to complex data formats. This, in turn, may enable the use of LLMs for converting text from multi-section natural language documents to structured data structures.

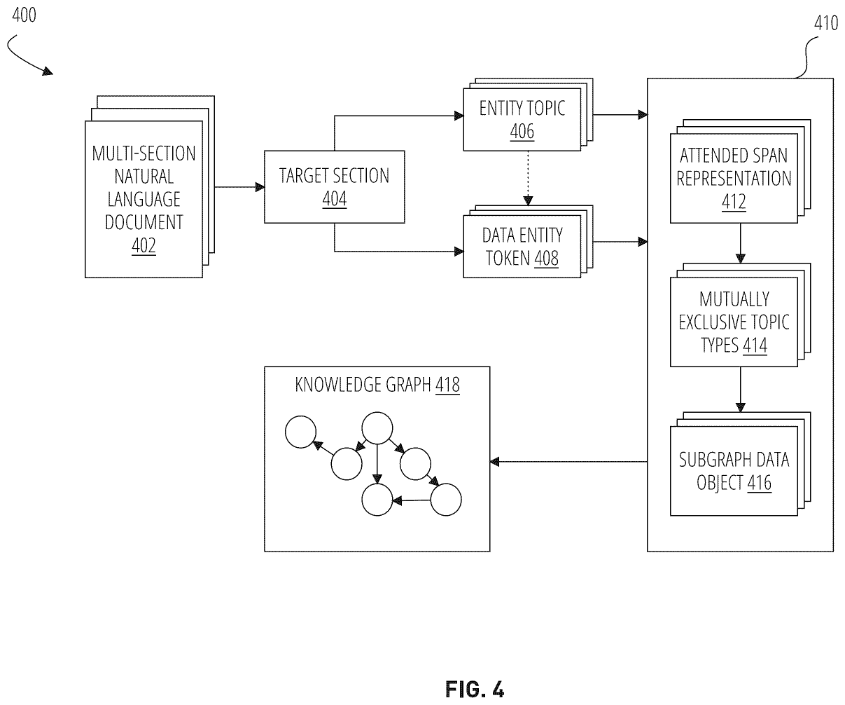

FIG. 4 is a dataflow diagram 400 showing example data structures and modules for converting complex, unstructured documents to a structured knowledge graph in accordance with some embodiments of the present disclosure. The dataflow diagram 400, for example, illustrates a multi-stage data conversion technique for extracting relationships from various sections defined within a plurality of multi-section natural language documents 402. To do so, the multi-stage data conversion technique may leverage a semantic chunking model 410 with a plurality of layers that are collectively configured to process each target section 404 identified within the plurality of multi-section natural language documents 402. As described herein, each target section may be processed to extract one or more text spans representative of topic related information from a target section 404. The text spans may be individually processed to generate a plurality of attended span representations 412 for grouping the text spans into mutually exclusive topic types 414. Once grouped, the text spans may be converted to subgraph data objects 416 and incorporated to a knowledge graph 418 representing structured information from a plurality of multi-section natural language documents 402. By doing so, large, unstructured textual information may be converted to a computer interpretable form that may support various downstream tasks, including query tasks, predictive modeling tasks, among others.

In some embodiments, a multi-section natural language document is received for an information domain. The multi-section natural language document may include one of a plurality of multi-section natural language documents 402 that include textual information relevant to the information domain.

In some embodiments, the multi-section natural language document is a data structure that describes textual information formatted according to one or more hierarchical sections. A multi-section natural language document, for example, may include a plurality of sections arranged according to one or more hierarchical relationships (e.g., subsection, etc.). A multi-section natural language document may express one or more entity topics 406 across one or more of the plurality of sections. In some examples, a multi-section natural language document may include textual information for each of a plurality of entity topics 406. The textual information may include one or more systematically developed statements. By way of example, in a clinical domain, a multi-section natural language document may include clinical practice guidelines with a plurality of systematically developed statements to assist practitioner and patient decisions about appropriate health care for specific clinical circumstances. The statements, for example, may contain recommendations that are based on evidence from a rigorous systematic review and synthesis of the published medical literature.

In some embodiments, a multi-section natural language document is a living document that is dynamically updated based on real world circumstances. A multi-section natural language document, for example, may include summaries of scientific evidence supporting one or more current recommendations that may change as the scientific evidence develops within a field. As an example, using the clinical domain, clinical practice guidelines may summarize medical knowledge, weigh the benefits and harms of diagnostic procedures and treatments, give specific recommendations based on this information, and must be updated based on based on changes to the summarized information.

A multi-section natural language document is created for human use without consideration of the technical challenges prevalent in computer interpretation of data. For this reason, there are several challenges for distilling computer interpretable rules from a multi-section natural language document, including complexities due to document lengths, frequency of updates, and the unstructured placement of different rule features that cannot be automatically consumed and analyzed by the computing systems.

In some embodiments, the above challenges are addressed using a semantic chunking model 410 and semantic chunking techniques. The semantic chunking techniques may leverage contextual chunking of a plurality of multi-section natural language documents 402 to divide the multi-section natural language documents 402 into candidate sections. In some examples, each candidate section may include one or more text spans (e.g., a set of guidelines associated with the context of a particular section, etc.) that may be individually processed and then compared against other text spans to create structured rules from the multi-section natural language documents 402.

In some examples, a multi-section natural language document may be processed to extract one or more hierarchical text attributes and/or determine a topic relevance of each candidate section (and/or text span thereof) of the multi-section natural language document. Both the hierarchy and topic relevance of each section may be preserved and leveraged by the semantic chunking model 410 to perform topic-based guideline abstraction by combining subsection extraction and topic extraction. This allows traditionally indecipherable multi-section natural language documents 402 to be processed and converted to meaningful sections of span representations that, using the techniques of the present disclosure, may be encoded within a searchable knowledge graph 418.

In some embodiments, a plurality of entity topics 406 are identified from a target section 404 of a multi-section natural language document of the plurality of multi-section natural language documents 402. The target section, for example, may be selected from a plurality of candidate sections of the multi-section natural language document. To do so, a plurality of hierarchical text attributes of the multi-section natural language document may be identified based on a formatting of the multi-section natural language document. The plurality of candidate sections may be identified based on the plurality of hierarchical text attributes. In some examples, the plurality of entity topics 406 may be identified based on the plurality of candidate sections and/or the plurality of hierarchical text attributes. In some examples, the plurality of entity topics 406 may be identified using an NLU model, such as such as DistilBERT, ALBERT, RoBERTa, ELECTRA, T5, GPT-2, GPT-3, and/or the like.

In some embodiments, a hierarchical text attribute is a data structure that describes a format characteristic of a multi-section natural language document. For example, a multi-section natural language document may be consumed, and a hierarchical organization of the document may be captured as a plurality of hierarchical text attributes. The hierarchical text attributes, for example, may identify one or more section identifiers, such as titles, subtitles, section headings, and/or the like, and/or any other structural characteristic of a multi-section natural language document. In some examples, one or more document insights may be derived based on the hierarchical text attributes. By way of example, NLU techniques may be leveraged to extract target insights, such as one or more data entity tokens 408, entity topics 406, and/or the like, from the hierarchical text attributes.

In some embodiments, the target section 404 is a data structure that describes a portion of text within a natural language document. The target section 404, for example, may include a section of text from a plurality of candidate sections defined by the formatting of a multi-section natural language document. The target section 404 may include one or more paragraphs, bullet points, lists, and/or the like within and/or associated with a section identifier. By way of example, the target section 404 may include a section title, such as “Diagnosis Guidelines Adults,” “Assess Risk Assessment,” and/or the like for a clinical guideline document. In some examples, the target section 404 may be associated with one or more entity topics.

In some embodiments, an entity topic is a data structure that describes a set of data entities with a unique representation and semantic meaning in text. An entity topic, for example, may include a plurality of data entity tokens 408 that are representative of a unique concept expressed by a portion of a multi-section natural language document. In some examples, a plurality of entity topics may be extracted from a multi-section natural language document. Example entity topics for a clinical domain, for example, may be related to diseases, cardiovascular, treatments, conditions, symptoms, side effects, guideline, and/or the like. In some examples, the plurality of entity topics extracted may referred to herein as “T.” Each topic may be represented by a collection of words and referred to a ti.

In some embodiments, a plurality of data entity tokens 408 is identified from the target section 404 of a multi-section natural language document of the plurality of multi-section natural language documents 402. The plurality of data entity tokens 408, for example, may be identified using an NLU model. In some examples, the plurality of data entity tokens 408 may be identified based on the plurality of entity topics 406.

In some embodiments, a data entity token is a data entity that describes a textual term (e.g., a sequence of alphanumeric characters, etc.) that has unique representation and semantic meaning in text. A data entity token, for example, may include a term that is recognized by an LLM (e.g., a learned entity from a vocabulary, etc.). In some examples, a data entity token may be domain specific. For instance, data entity tokens may include disease types (e.g., Dyslipidemia, Disease, etc.) for a clinical domain.

In some embodiments, the one or more entity topics 406 and the plurality of data entity tokens 408 are provided as input to a semantic chunking model 410. The semantic chunking model 410 may be configured to generate an attended span representation 412 for each of a plurality of text spans within the target section 404. The semantic chunking model 410 may compare the resulting attended span representations 412 against themselves and topic embeddings of the entity topics 406 to assign mutually exclusive topic types 414 to each of the plurality of text spans. By doing so, the semantic chunking model 410 may generate subgraph data objects 416 from the data entity tokens 408 based on the mutually exclusive topic types 414 respectively assigned to the plurality of text spans. The subgraph data object 416 may be combined to generate a holistic knowledge graph 418 descriptive of the relationships expressed by the target section 404 of the multi-section natural language document.

In some embodiments, the knowledge graph 418 is a data structure that describes a plurality of linked concepts from a plurality of multi-section natural language documents 402. The knowledge graph 418, for example, may include a graph-based data structure that is generated and continuously modified for a particular knowledge domain. The knowledge graph 418 may be continuously modified, using some of the techniques of the present disclosure, using extracted data entity and entity topics for a set of section text spans using span representations, as described herein.

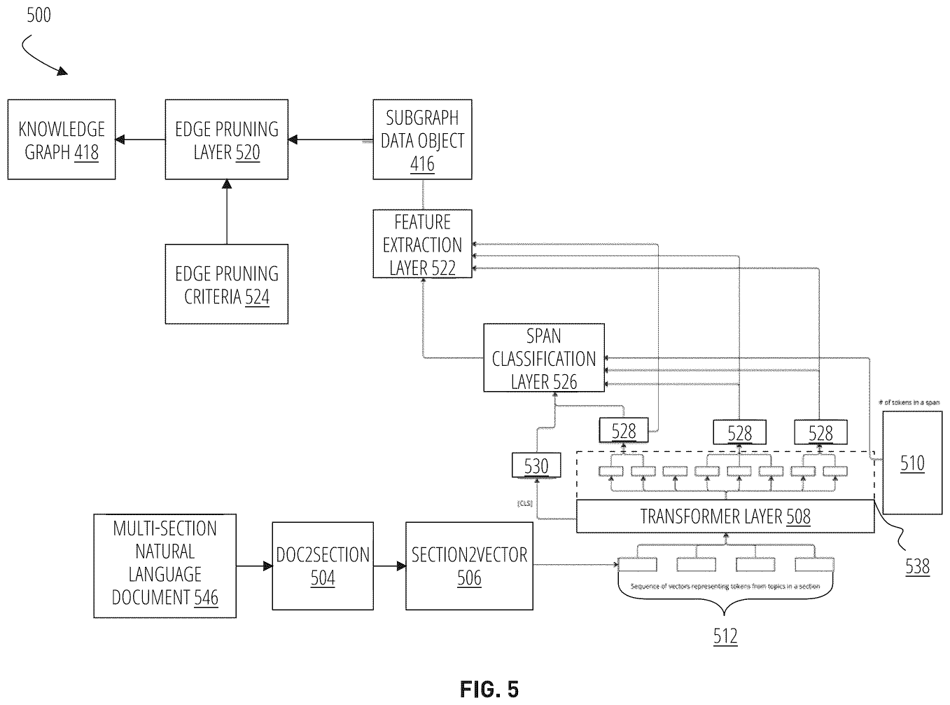

In some embodiments, the semantic chunking model 410 leverages a modified LLM architecture to generate subgraph data objects from a plurality of text spans. The modified LLM architecture may include a plurality of layers specially designed to address technical challenges that traditionally inhibit the use of LLMs with multi-section natural language documents 402. The modified architecture is described in further detail with respect to FIG. 5.

FIG. 5 is an operational example 500 of a semantic chunking technique that leverages a modified large language model architecture in accordance with some embodiments of the present disclosure. The semantic chunking techniques, for example, may leverage a semantic chunking model 410 with a plurality of layers specifically tailored for a data conversion process with multi-section natural language documents 402. In this regard, multi-section natural language documents 402 present a number of technical challenges for traditional LLMs, including an inability to connect information from disparate sections into mutually exclusive topics. These technical challenges inhibit the performance of LLMs with respect to several tasks, such as the data conversion techniques of the present disclosure. To address these challenges, some embodiments of the present disclosure present a semantic chunking model 410 with a modified LLM architecture. The modified LLM architecture includes a plurality of layers, as shown herein, to generate span-level attentions that may be leveraged to effectively identify and group segments of text from across different sections of a multi-section natural language document 546 without losing the hierarchical text attributes defined by the multi-section natural language document 546.

In some embodiments, a semantic chunking model 410 is a data structure that describes parameters, hyper-parameters, and/or defined operations of a rules-based and/or machine learning model (e.g., model including at least one of one or more rule-based layers, one or more layers that depend on trained parameters, coefficients, and/or the like). The semantic chunking model 410 may include any type of model configured, trained, and/or the like to process input text and, in response to the input text, output one or more textual insights, such as classifications and/or extracted components from the text based on the classifications. In some examples, the semantic chunking model 410 may include a modified LLM architecture with a plurality of layers specially designed for a text classification process. Each of the layers of the modified LLM may include one or more classification, embedding, and/or attending layers constructed using any type of model architecture, including transformers, neural networks, decision trees, algorithmic, and/or the like.

In some embodiments, the semantic chunking model 410 may include a generative pretrained transformer that is modified with a span self-attention mechanism to generate a plurality of token-level span attention vectors 528 with respect to a text span embedding 510 of a text span extracted from a target section of a multi-section natural language document 546. The semantic chunking model 410 may implement a workflow to construct dynamic edges and establish relationships within sections of a multi-section natural language document 546. The semantic chunking model architecture may leverage the text span embeddings 510, token-level span attention vectors 528, and a span classification layer 526 to filter out valid text spans from candidate sections from a plurality of multi-section natural language documents for chunking. The chunking process may be repeated for all possible spansj,k up to a given length in a target section for each section across each of the plurality of multi-section natural language documents to generate a knowledge graph 418 derived from the plurality of multi-section natural language documents. In this manner, a semantic chunking model 410, as described herein, may leverage the capabilities of LLMs with updated design to build a knowledge management system to extract rule-based structured guidance from unstructured textual guidelines.

In some embodiments, the semantic chunking model 410 includes a machine learning pipeline with a plurality of layers collectively configured to build the knowledge graph 418 from text spans extracted across a plurality of multi-section natural language documents. The plurality of layers, for example, may include (a) an embedding layer configured to generate a text span embedding 510 for a text span, (b) a transformer layer 508 configured to generate token-level span embeddings for input data entity tokens and a document classification vector 530 for a document corresponding to the input data entity tokens, (c) a span attention layer 538 configured to attend the token-level span embeddings based on a particular text span to generate a token-level span attention vectors 528, (d) a span classification layer 526 configured to generate an attended span representation and assign a text span to an entity topic and/or mutually exclusive topic type, (e) a feature extraction layer 522 configured to extract entity factor nodes and entity factor edges from valid text spans, (f) an edge pruning layer 520 configured to remove nodes and edges in accordance with edge pruning criteria 524, among other layers.

In some embodiments, the semantic chunking model 410 receives two inputs, a text span embedding 510 and a token sequence 512 of token vectors. The text span embedding 510 and the token sequence 512 may be processed to generate token-level span attention vectors 528. In some examples, the token sequence 512 may be derived from section vectors that encapsulate hierarchical text attributes of a multi-section natural language document 546. For example, a plurality of section vectors may be generated from the multi-section natural language document 546 based on the plurality of candidate sections. The section vectors, for example, may be generated by applying doc2section 504 to the multi-section natural language document 546 and then applying section2vector 506 to the output of the doc2section 504. The plurality of section vectors may include a target vector for a target section that encodes one or more of the plurality of hierarchical text attributes associated with the target section. A plurality of token vectors (e.g., token sequence 512) may be extracted from the target vector based on the plurality of data entity tokens.

In some embodiments, the plurality of data entity tokens is identified from a target section of a multi-section natural language document 546 based on a sentence relevancy prediction. For instance, a plurality of sentence relevancy predictions may be generated, using a supervised machine learning model, for a plurality of section sentences of the target section. One or more relevant sentences may be identified from the plurality of section sentences based on the plurality of sentence relevancy predictions. In some examples, the plurality of data entity tokens may be identified from the one or more relevant sentences.

In some embodiments, a token vector is a vectorized representation of a data entity token. In some examples, a token vector may include an input to a semantic chunking model 410 that encodes a data entity token from a target section as well as hierarchical text attributes associated with the data entity token. For example, a semantic chunking model 410 may receive a sequence of token vectors tᵢ . . . , . . . , . . . tⱼ of a target section (e.g., a token sequence 512). Each of the token vectors may be embedded as a sequence of high dimensional vectors representing data entity tokens of one or more entity topics expressed by the target section.

In some examples, the token sequence 512 may be extracted from one or more relevant sentences of the target section. For instance, the token sequence 512 may be extracted from Ø_{sentence}≥Ø_{Threshold}, where Ø_{sentence} includes sentences with a relevancy score that exceed a tunable threshold relevance (e.g., 0.8, 0.9, etc.). The resulting token sequence 512 may correspond to a set of data entity tokens {eⱼ, eₖ, Ø}∈E_{E} ranging in a topic (set of entities in a section (j) of a document (k) from relevant sentences Ø). In some examples, the relevancy score for a sentence may be generated by a supervised machine learning model.

In some examples, a relevancy of a sentence may be based on the following document relevance criteria: (a) highly relevant: leading section associated with topics mentions topic-specific arguments, reports (evidence); (b) somewhat relevant: leading section uses mentions from identified topics in its leading section to substantiate central topic in a section, (c) not relevant: Document section is on topic, information contained in document may only help as a secondary source, nice to have information; and (d) off topic: sections in document is off topic. In some examples, the context of a multi-section natural language document 546 may be synthesized by collecting a set of “N” topics and associated candidate sections representing specific guidelines and sampling relationships between topics and sections. The relationships may be recorded as contextual edges “E” between entity topics and candidate sections in a multi-section natural language document 546, contextual_{edges}=[(t₁, r₁s₁) . . . (tᵢ, rₖsⱼ)]. Once the contextual edges are defined, topics tⱼ and tⱼ may be selected from related sections to compute weights of their sentence relevance Ø_{sentence}.

In some embodiments, a sentence relevancy prediction is a determination of whether a candidate sentence of a target section is relevant for a semantic chunking process. In some examples, the sentence relevancy prediction may be determined based on a comparison between a relevancy score output by a supervised machine learning model and a tunable relevancy threshold.

In some embodiments, a supervised machine learning model is a data structure that describes parameters, hyper-parameters, and/or defined operations of a rules-based and/or machine learning model (e.g., model including at least one of one or more rule-based layers, one or more layers that depend on trained parameters, coefficients, and/or the like). The supervised machine learning model may include any type of model configured, trained, and/or the like to process input text and, in response to the input text, output a sentence relevancy prediction for the input text. In some examples, the supervised machine learning model may include a neural network architecture that is trained, using backpropagation of errors, to optimize a classification loss. The supervised machine learning model may be trained using a plurality of training data entries. Each training data entry may include a relevancy label (e.g., binary, relevancy type label, such as highly relevant, somewhat relevant, not relevant, off topic, etc.), training text, and one or more training features, such a training hierarchical text attribute.

In some embodiments, a text span is identified from a target section of a multi-section natural language document 546. In some embodiments, the text span may be provided as an input to the semantic chunking model 410.

In some embodiments, a text span is a data structure that describes a segment of text (e.g., a sequence of alphanumeric characters, etc.) from a target section of a multi-section natural language document 546. For example, a multi-section natural language document 546 may be split into a plurality of pieces of texts (e.g., text spans) with a goal of avoiding blind document chunks. Each text span may be individually processed with the context of a section from which it was extracted to remove unrelated, out of scope pieces of text from the multi-section natural language document 546 and focus on relevant pieces of text that encapsulate an otherwise long document in a collection of semantically connected pieces of texts.

In some examples, a text span may include one or more data entity tokens connected by entity relationship tokens. The entity relationship tokens may semantically connect at least a pair of data entity tokens to form a token-to-token relationship that defines a condition with respect to an entity topic. By way of example, in a clinical domain, text spans may include:

$$[ ( LDL - C \geq 5 mmol / L ) OR ( ApoB \geq 1.45 g / L ) OR ( non - HDL - C \geq 5.8 mmol / L ) OR ( documented familial hypercholestrolemia ) ] ,$$

In some examples, a text span may include a reference to another, sub-text span, such as the documented familiar hypercholesteremia text span in the above example, which may be represented as:

$$( ( LDL - C \geq 5 mmol / L ) OR ( ApoB \geq 1.45 g / L ) OR ( non - HDL - C \geq 5.8 mmol / L ) ) )$$

Using the techniques of the present disclosure, a plurality of text spans may be extracted from a multi-section natural language document 546 and processed by the semantic chunking model 410 to assign each text span to an entity topic. In some embodiments, one or more text spans assigned to an entity topic may be processed to extract a plurality of tuples for the entity topic using the semantic chunking model 410. By way of example, in a multi-section natural language document 546 with sections, sci, and an entity topic extracted as tᵢ=“Assess cardiovascular risk,” a plurality of tuples, T, may be extracted as shown below using a clinical example:

### A.

1. Statin-indicated conditions (patients are automatically considered to be at high cardiovascular risk):
a. LDL-C≥5 mmol/L, ApoB 1.45 g/L, non-HDL-C 5.8 mmol/L or documented familial hypercholesterolemia tuple:
(patient, is_defined_by, Statin-indicated conditions);
(LDL-C, is_larger_or_equal, 5 mmol/L);
(ApoB, is_larger_or_equal, 1.45 g/L);
(non-HDI-C, is_larger_or_equal, 5.8 mmol/L);
(familial hypercholesterolemia, is_documented, true)
b. Most patients with diabetes mellitus:
i. ≥40 years of age, or
(patient, has, diabetes mellitus);
(patient, is_larger_or_equal, 40 years of age)
ii. ≥30 years of age with ≥15 years' duration, or
(patient, is_larger_or_equal, 30 years of age);
(diabetes mellitus, has_duration, ≥15 years)
iii. presence of microvascular complications
(patient, has_symptom, microvascular complications)
c. Chronic kidney disease (CKD) not treated with chronic dialysis, defined as age ≥50 years and estimated glomerular filtration rate <60 mL/min/1.73 m or albumin-to-creatinine ratio >3 mg/mmol
(patient, has, Chronic kidney disease (CKD);
(CKD, not_treated_with, chronic dialysis);
(patient, is_larger_or_equal, 50 years);
(estimated_glomerular_filtration_rate, is_smaller, 60 ml/min/1.73 m);
(albumin-to-creatinine_ratio, is_larger, 3 mg/mmol)
d. Patients with ASCVD (this refers to all clinical conditions of atherosclerotic origin):
i. Coronary artery disease:
Acute coronary syndrome (ACS)
(patient, has, Coronary artery disease);
(Coronary artery disease, has_symptom, Acute coronary syndrome (ACS))
History of coronary artery bypass graft surgery or coronary stenting
(Coronary artery disease, has_history_of, coronary artery bypass graft surgery);
(Coronary artery disease, has_history_of, coronary stenting)
Stable or unstable angina
(Coronary artery disease, has_symptom, stable angina);
(Coronary artery disease, has_symptom, unstable angina)
Documented coronary artery disease by angiography
(Coronary artery disease, is_documented_by, angiography)
   ii. Cerebrovascular disease:
Stroke
(Cerebrovascular disease, has_symptom, stroke)
Transient ischemic attack
(Cerebrovascular disease, has_symptom, transient ischemic attack)
Documented carotid disease
(Cerebrovascular disease, has_symptom, documented carotid disease)
   iii. Peripheral artery disease:
Claudication and/or ankle-brachial index <0.9
(Peripheral artery disease, has_sym claudication);
(ankle-brachial index, is_smaller, 0.9)
Femoral popliteal bypass graft surgery
(Peripheral artery disease, has_symptom, femoral popliteal bypass graft surgery)
Abdominal aortic aneurysm (atherosclerosis is a known culprit):
   Abdominal aorta >3.0 cm
   (Abdominal aortic aneurysm, has_symptom, abdominal aorta >3.0 cm)
   Previous aortic aneurysm surgery
   (Abdominal aortic aneurysm, has_history of, aortic aneurysm surgery)
      Section B: Primary prevention patients:
      a. Cardiovascular risk assessment:
i. Modified Framingham 10-year Risk Score (FRS)
   (Primary prevention patients, assess, Cardiovascular risk);
   (Cardiovascular risk, is_assessed_by, Modified Framingham 10-year Risk Score (FRS))
ii. Cardiovascular age with the Cardiovascular Life Expectancy Model
   (Cardiovascular risk, is_assessed_by, Cardiovascular age);
   (Cardiovascular age, uses, Cardiovascular Life Expectancy Model)
iii. Women with hypertensive disorders of pregnancy favoring cardiovascular age over 10-year risk calculators
   (Women, with, hypertensive disorders of pregnancy);
   (hypertensive disorders of pregnancy, prefer, cardiovascular age over 10-year risk calculators)
   Section B: Coronary artery calcium (CAC) score:
   b.i. CAC score testing with computed tomography scan of the chest
   (CAC score testing, is_done_by, computed tomography scan of the chest)
   b.ii. Intermediate-risk patients and subset of low-risk patients may undergo CAC screening.
   (Intermediate-risk patients, may_have, CAC screening);
   (Subset of low-risk patients, may_have, CAC screening)
   CAC measurement:
   >0 Agatston units (AU) confirms the presence of atherosclerotic plaque
   tuple: (CAC measurement, is_larger_than, 0 AU);
   (Atherosclerotic plaque, is_confirmed_by, CAC measurement >0 AU)
   >100 AU indicates significant coronary plaque burden and is considered a statin-indicated condition tuple: (CA measurement, is_larger_than, 100 AU);
   tuple: (CAC measurement, is_larger_than, 100 AU);
   (Significant coronary plaque burden, is_indicated_by, CAC measurement >100 AU);
   (Statin-indicated condition, is_identified_by, CAC measurement >100 AU)
   Pharmacists can play an active role in identifying patients to help initiate statin therapy
   tuple: (Pharmacists, can_play, active role in identifying patients);
   (Pharmacists, can_help_initiate, statin therapy)

In some embodiments, the entity relationship token is a data entity that describes a textual term (e.g., a sequence of alphanumeric characters, mathematical symbols, etc.) that defines a unique relationship between two data entity tokens. An entity relationship, for example, may include a factor edge indicative of a relationship between two data entity tokens that may be expressed as a conditional statement, such as a mathematical operator (e.g., ≥, =, etc.). In addition, or alternatively, an entity relationship token may include span edge indicative of a relationship between two conditional statements relative to a topic. A span edge, for example, may be expressed as a joining condition (e.g., AND, OR, etc.) that defines a combination of conditional statements to achieve one or more results with respect to an entity topic.

In some embodiments, a text span embedding 510 may be generated, using an embedding layer of the semantic chunking model 410, for the text span of the target section. In some embodiments, the embedding layer is a data structure that describes parameters, hyper-parameters, and/or defined operations of a rules-based and/or machine learning model (e.g., model including at least one of one or more rule-based layers, one or more layers that depend on trained parameters, coefficients, and/or the like). The embedding layer, for example, may include a machine learning layer of the semantic chunking model 410. The embedding layer may include an encoder-only layer, including one or more feed-forward neural networks, and/or the like. The embedding layer may be configured to generate a text span embedding 510 from an input text span. In some examples, the embedding layer may include a pretrained encoder-only model, such as bidirectional encoder representations from transformers (BERT) model.

In some embodiments, the text span embedding 510 is a vectorized representation of a text span. A text span embedding, for example, may include a token-level embedding of a plurality of data entity tokens of the text span.

In some embodiments, a plurality of token-level span attention vectors 528 is generated for the plurality of data entity tokens 408 based on the text span. The token-level span attention vectors 528, for example, may be generated using a span attention layer 538 of the semantic chunking model 410. In some examples, the span attention layer 538 may attend one or more features output by a transformer layer 508 of the semantic chunking model 410. For instance, the transformer layer 508 may output a token-level span embedding for each of the plurality of token vectors within the token sequence 512. And the span attention layer 538 may generate a token-level span attention vector 528 for each of the plurality of token vectors based on their respective token-level span embeddings.

By way of example, the transformer layer 508 may be configured to output a plurality of token-level span embeddings and a document classification vector 530. The plurality of token-level span attention vectors 528 may be generated, using the span attention layer 538 of the semantic chunking model 410, based on the plurality of token-level span embeddings.

In some embodiments, the transformer layer 508 is a data structure that describes parameters, hyper-parameters, and/or defined operations of a rules-based and/or machine learning model (e.g., model including at least one of one or more rule-based layers, one or more layers that depend on trained parameters, coefficients, and/or the like). The transformer layer 508, for example, may include a machine learning layer of the semantic chunking model 410. In some examples, the transformer layer 508 may include a BiRNN architecture. The transformer layer 508 may be configured to generate a plurality of token-level span embeddings for a sequence of input token vectors. In addition, or alternatively, the transformer layer 508 may be configured to generate a document classification vector 530.

In some embodiments, the span attention layer 538 is a data structure that describes parameters, hyper-parameters, and/or defined operations of a rules-based and/or machine learning model (e.g., model including at least one of one or more rule-based layers, one or more layers that depend on trained parameters, coefficients, and/or the like). The span attention layer 538, for example, may include a machine learning attention layer of the semantic chunking model 410. In some examples, one or more span attention layers 538 may be appended to the transformer layer 508. The span attention layers 538 may receive token-level span embeddings and perform one or more attention operations for attending the token-level span embeddings with respect to an input text span. The resulting token-level span attention vectors 528 may be output for each input text span and a set of input data entity tokens.

In some embodiments, the token-level span attention vector 528 is a weighted vectorized representation of a data entity token that is weighted based on a correlation with an input text span.

In some embodiments, the document classification vector 530 is a weighted vectorized representation of the multi-section natural language document 546, and/or portion thereof, that corresponds to a particular text span. The document classification vector 530, for example, may include a classify token (CLS) designed to represent information from complete text.

In some embodiments, an attended span representation 412 is generated for the text span based on the text span embedding 510 and the plurality of token-level span attention vectors 528. In some embodiments, an attended span representation is a weighted vectorized representation of a text span. An attended span representation 412, for example, may include an aggregation of a text span embedding 510 with a plurality of token-level span attention vectors 528. For instance, attended span representations, spansj,k, may be generated by concatenating together the attention representations of span and span embeddings (covering all possible spans). Each valid span of length 1 looks up different vector of learned parameters associated with a mutually exclusive category for a particular entity topic.

In some embodiments, an entity topic is identified that corresponds to the text span based on the attended span representation 412. The entity topic, for example, may be identified using a span classification layer 526 of the semantic chunking model 410. In some examples, the entity topic may be identified based on the attended span representation 412 and the document classification vector 530.

In some embodiments, the entity topic is identified based on an embedding comparison between a plurality of topic embeddings and the attended span representation 412. For instance, a plurality of topic embeddings may be received that respectively correspond to the plurality of entity topics. The entity topic may be identified, using the span classification layer 526 of the semantic chunking model 410, based on a comparison between the plurality of topic embeddings and the attended span representation 412. In some embodiments, a type classification prediction is generated, using the span classification layer 526 of the semantic chunking model 410, for the text span that identifies a mutually exclusive topic type from one or more mutually exclusive topic types associated with the entity topic.

In some embodiments, the span classification layer 526 is a data structure that describes parameters, hyper-parameters, and/or defined operations of a rules-based and/or machine learning model (e.g., model including at least one of one or more rule-based layers, one or more layers that depend on trained parameters, coefficients, and/or the like). The span classification layer 526, for example, may include a machine learning layer of the semantic chunking model 410. In some examples, the span classification layer 526 may generate and then leverage an attended span representation 412 for each of a plurality of text spans to classify each individual text span as (a) valid (e.g., relevant to at least one topic, etc.) or invalid (e.g., irrelevant to all entity topics, etc.) and (b) into mutually exclusive types. In some examples, only valid text spans are passed to a subsequent layer of the semantic chunking model 410 to be processed further for extraction of relationships between factors and factor-edges. In this manner, the span classification layer 526 may remove irrelevant portions of sections being considered as well as bring in any left-out sections from different sections of a multi-section natural language document 546 and/or a set of multi-section natural language documents. The span classification layer 526 may generate one or more span classifications based on one or more vector grouping techniques (e.g., nearest neighbors search, etc.) and/or vector comparison scores (e.g., cosine similarity, etc.).

In some embodiments, a topic embedding is a vectorized representation of an entity topic. A topic embedding, for example, may include a token-level embedding of a plurality of data entity tokens of the entity topic.

In some embodiments, a type classification prediction is an output of a span classification layer 526 for a text span. A type classification prediction may be indicative of a validation of a text span (e.g., that the text span is relevant to at least one entity topic). In addition, or alternatively, the type classification prediction may be indicative of a mutually exclusive topic type corresponding to the text span.

In some embodiments, the mutually exclusive topic type is a type of type classification prediction. A mutually exclusive topic type may include a grouping identifier to distinguish between different groups of text spans related to a single entity topic. By way of example, different text spans in the context of Dyslipidemia may be described as a Disease, Symptom, Condition, Treatment, Demography, Side Effect, Risk, and/or other mutually exclusive topic types.

In some embodiments, responsive to an identification of the entity topic, a subgraph data object 416 is generated for a knowledge graph 418 using the text span. In some examples, the text span may be identified as a valid span in response to a type classification prediction satisfying a classification threshold. In some examples, the subgraph data object may be generated for the mutually exclusive topic type.

In some examples, the knowledge graph 418 may include a plurality of section topic subgraphs respectively corresponding to a plurality of section topic pairs from a plurality of a multi-section natural language documents. The subgraph data object 416 may include a span portion of a section topic subgraph of the plurality of section topic subgraphs that corresponds to the target section 404 and the entity topic. The section topic subgraph, for example, may include one or more span portions respectively corresponding to one or more text spans of the target section 404.

The subgraph data object 416 for a text span may be generated based on one or more data entity tokens of the text span. For example, a text span may include a subset of the plurality of data entity tokens within a target section. In addition, or alternatively, the text span may include one or more entity relationship tokens associated with the subset of data entity tokens. In some examples, one or more entity factor nodes for a subgraph data object 416 may be generated, using the feature extraction layer 522, that respectively correspond to the subset of data entity tokens. In addition, or alternatively, one or more entity factor edges between the one or more entity factor nodes may be generated, using the feature extraction layer 522, that respectively correspond to the one or more entity relationship tokens.

In some embodiments, the feature extraction layer 522 is a data structure that describes parameters, hyper-parameters, and/or defined operations of a rules-based and/or machine learning model (e.g., model including at least one of one or more rule-based layers, one or more layers that depend on trained parameters, coefficients, and/or the like). The feature extraction layer 522, for example, may include an NLP layer of the semantic chunking model 410 that is configured to extract data entity tokens and entity relationship tokens from a valid text span. As described herein, the feature extraction layer 522 may generate, modify, and/or remove nodes and/or edges from a subgraph data object 416 in accordance with one or more data entity tokens (e.g., attributes Ar) and/or entity relationship tokens extracted from the valid text span. By way of example, the feature extraction layer may perform the following operations:

```
$Input : span {s}_{i} extracted from set of documents {\sum }_{k = 0}^{n} {d}_{k} with entities {E}_{ε} ∈ {t}_{i}$
Initialization
for span s in sᵢ do
    for topics t in tᵢ, tᵢ ∈ s do
      for attributes Aᵣ in span s in span section ss of topic t do
        Insert f as factor and association of factor as factor_{edges} in node N such that f ∈ Aᵣ
      if length of span representation is < threshold then
        Insert node nᵢ in span representation Sᵣ as subnode of topic t
    while span_{length} ≤ permissible_{pathLength} do
      path = path + nᵢ where nᵢ (factor, factor_{edges})
end
Output: Span Representation (Contextual Semantic Chunking + Relationship)
```

By way of example, factors and factor edges may be modified using the following semantic operations: factor insertion, factor deletion, factor substitution, factor edges insertion, factor edges deletion, factor edges substitution where association of disjoint factors is achieved using co-span distance from span section and associated entity topics.

In some embodiments, the subgraph data object 416 is a portion of a knowledge graph 418 that corresponds to a text span from a multi-section natural language document 546. A subgraph data object 416, for example, may include a plurality of entity factor nodes and entity factor edges extracted from a particular text span of a target section within a multi-section natural language document 546 of a plurality of multi-section natural language documents. In some embodiments, the entity factor node is a component of the knowledge graph 418. An entity factor node may describe a relevant factor for an entity topic. The relevant factor, for example, may correspond to a data entity token of a text span. In some embodiments, the entity factor edge is a component of a knowledge graph 418. An entity factor edge may describe a relevant condition for an entity topic. The relevant condition, for example, may correspond to an entity relationship token of a text span.

In some embodiments, an entity factor edge from the one or more entity factor edges is removed based on one or more edge pruning criteria. The entity factor edge, for example, using an edge pruning layer 520 of the semantic chunking model 410.

In some embodiments, the edge pruning layer 520 is a data structure that describes parameters, hyper-parameters, and/or defined operations of a rules-based and/or machine learning model (e.g., model including at least one of one or more rule-based layers, one or more layers that depend on trained parameters, coefficients, and/or the like). The edge pruning layer 520, for example, may include an algorithmic filtering layer of the semantic chunking model 410. An edge pruner helps to analyze any inconsistent relationships that may be optionally discarded in case either model confidence is low, or it is found to be inconsistent/contrast as compared to available guidelines.

In some embodiments, the edge pruning criteria 524 is a data structure that describes one or more edge restrictions for a knowledge graph 418. The edge pruning criteria 524 may be tunable based on the knowledge domain. In some examples, the edge pruning criteria 524 may establish a confidence threshold, a compliance with one or more ground truth rulesets, and/or the like.

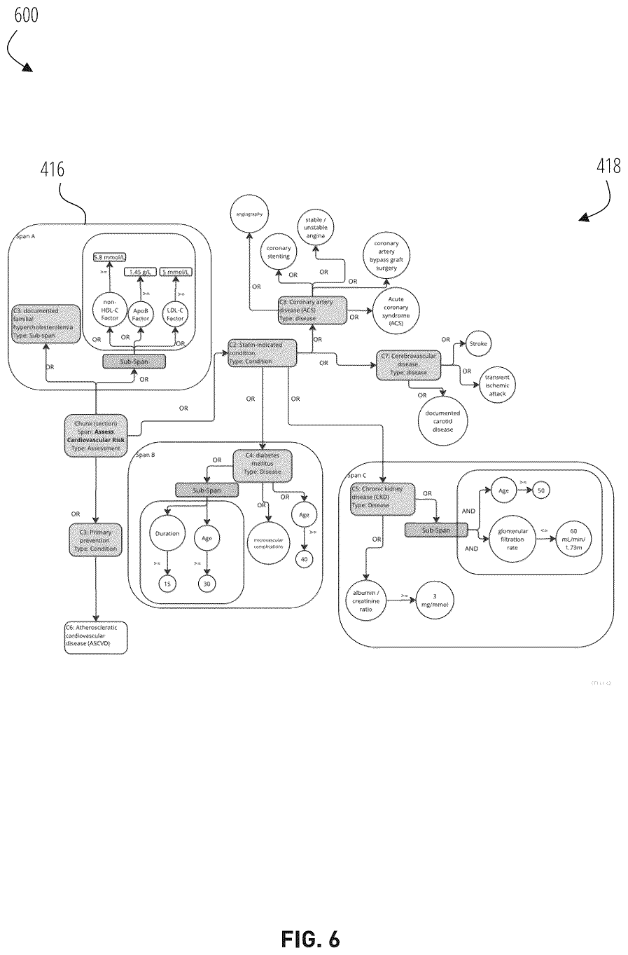

A knowledge graph 418 may be generated by applying the semantic chunking model 410 to each of a plurality of candidate text spans from a plurality of different target sections across a plurality of different multi-section natural language documents within a knowledge domain. An example knowledge graph 418 is illustrated below with reference to FIG. 6.

FIG. 6 is an operational example 600 of a knowledge graph for a clinical domain in accordance with some embodiments of the present disclosure. The operational example 600 depicts a knowledge graph 418 of a clinical domain for example purposes. The knowledge graph 418 may be converted from a plurality of unstructured, multi-section natural language documents that detail clinical guidelines for a plurality of different topics, including disease and/or the like. The operational example 600 depicts a subgraph of the knowledge graph 418 that corresponds to a mutually exclusive topic type. In this example, the mutually exclusive topic type is an “Assessment” for the entity topic of “Cardiovascular Risk.” The subgraph includes a plurality of entity factor nodes connected by a plurality of entity factor edges that are extracted from text spans, using the techniques of the present disclosure. As depicted, groups of entity factor nodes and entity factor edges (e.g., subgraph data object 416) may correspond to a text span that is classified as related to the mutually exclusive topic type for the entity topic.

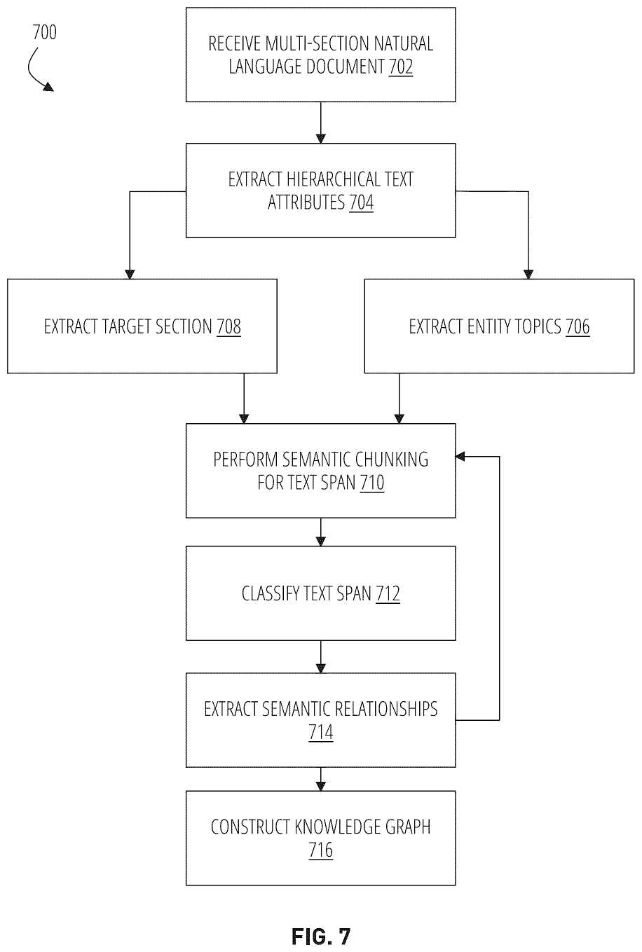

FIG. 7 is a flowchart diagram of an example process 700 for converting complex, unstructured documents to a structured knowledge graph in accordance with some embodiments of the present disclosure. The flowchart depicts a data processing technique that leverages a new semantic chunking model to improve the language modelling operations with respect to the interpretation of multi-section natural language documents. The process 700 may be implemented by one or more computing devices, entities, and/or systems described herein. For example, via the various steps/operations of the process 700, the computing system 101 may leverage improved language model architectures to interpret and extract span-level insights from a corpus of multi-section natural language documents. By doing so, the process 700 enables the generation of structured data, such as a knowledge graph, from text that is historically challenging for LLMs.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, receiving a multi-section natural language document. For example, the computing system 101 may receive a multi-section natural language document from a plurality of multi-section natural language documents associated with a knowledge domain.

In some embodiments, the process 700 includes, at step/operation 704, extracting hierarchical text attributes from the multi-section natural language document. For example, the computing system 101 may identify a plurality of hierarchical text attributes of the multi-section natural language document based on a formatting of the multi-section natural language document.

In some embodiments, the process 700 includes, at step/operation 706, extracting entity topics from the multi-section natural language document. For example, the computing system 101 may identify the plurality of candidate sections based on the plurality of hierarchical text attributes. The computing system 101 may identify, using an NLU model, a plurality of entity topics based on the plurality of candidate sections and the plurality of hierarchical text attributes.

In some embodiments, the process 700 includes, at step/operation 708, extracting a target section from the multi-section natural language document. The computing system 101 may select the target section from the plurality of candidate sections of the multi-section natural language document. In some examples, the computing system 101 may identify, using an NLU model, a plurality of data entity tokens from the target section of a multi-section natural language document. The computing system 101 may identify a plurality of data entity tokens based on the plurality of entity topics.

In some examples, the computing system 101 may generate, using a supervised machine learning model, a plurality of sentence relevancy predictions for a plurality of section sentences of the target section. The computing system 101 may identify one or more relevant sentences from the plurality of section sentences based on the plurality of sentence relevancy predictions and identify the plurality of data entity tokens from the one or more relevant sentences.

In some embodiments, the process 700 includes, at step/operation 710, performing semantic chunking for a text span from the target section. For example, the computing system 101 may generate, using an embedding layer of a semantic chunking model, a text span embedding for a text span of the target section.

In addition, or alternatively, the computing system 101 may generate a plurality of section vectors from the multi-section natural language document based on the plurality of candidate sections. The plurality of section vectors may include a target vector for the target section that encodes one or more of the plurality of hierarchical text attributes associated with the target section. The computing system 101 may extract a plurality of token vectors from the target vector based on the plurality of data entity tokens. The computing system 101 may generate, using a transformer layer of the semantic chunking model, a token-level span attention vector for each of the plurality of token vectors. In some examples, the transformer layer may be configured to output a plurality of token-level span embeddings and a document classification vector.

The computing system 101 may generate, using a span attention layer of the semantic chunking model, a plurality of token-level span attention vectors for the plurality of data entity tokens based on the text span. In some examples, the plurality of token-level span attention vectors may be generated, using the span attention layer of the semantic chunking model, based on the plurality of token-level span embeddings.

The computing system 101 may generate an attended span representation for the text span based on the text span embedding and the plurality of token-level span attention vectors. In some examples, the entity topic may be identified based on the attended span representation and the document classification vector.

In some embodiments, the process 700 includes, at step/operation 712, classifying the text span through one or more semantic chunking operations. For example, the computing system 101 may identify, using a span classification layer of the semantic chunking model, an entity topic that corresponds to the text span based on the attended span representation. In some examples, the computing system 101 may identify, using the NLU model, a plurality of entity topics from the multi-section natural language document. The computing system 101 may receive a plurality of topic embeddings respectively corresponding to the plurality of entity topics. The computing system 101 may identify, using the span classification layer of the semantic chunking model, the entity topic based on a comparison between the plurality of topic embeddings and the attended span representation.

In some examples, the computing system 101 may generate, using the span classification layer of the semantic chunking model, a type classification prediction for the text span that identifies a mutually exclusive topic type from one or more mutually exclusive topic types associated with the entity topic. In response to the type classification prediction satisfying a classification threshold, the computing system 101 may identify the text span as a valid span and generate a subgraph data object for the mutually exclusive topic type at step/operation 716.

In some embodiments, the process 700 includes, at step/operation 714, extracting semantic relationships from the classified text span. For example, the computing system 101 may extract the semantic relationship from a text span in response to an identification that the text span corresponds to an entity topic. The text span may include a subset of the plurality of data entity tokens and one or more entity relationship tokens associated with the subset of data entity tokens. The computing system 101 may generate one or more entity factor nodes respectively corresponding to the subset of data entity tokens. The computing system 101 may generate one or more entity factor edges between the one or more entity factor nodes and respectively corresponding to the one or more entity relationship tokens. In some examples, the computing system 101 may remove an entity factor edge from the one or more entity factor edges based on the one or more edge pruning criteria.

In some embodiments, the process 700 includes, at step/operation 716, constructing the knowledge graph based on the extracted semantic relationships. For example, the computing system 101 may, responsive to an identification of the entity topic, generate a subgraph data object for a knowledge graph using the text span. In some examples, the knowledge graph may include a plurality of section topic subgraphs respectively corresponding to a plurality of section topic pairs from a plurality of a multi-section natural language documents. The subgraph data object may include a span portion of a section topic subgraph of the plurality of section topic subgraphs that corresponds to the target section and the entity topic. In some examples, the section topic subgraph may include one or more span portions respectively corresponding to one or more text spans of the target section.

In some embodiments, the process 700 may return to step/operation perform 710 to individually process each text span within a length threshold from the target section.

Some techniques of the present disclosure enable the generation of action outputs that may be performed to initiate one or more real world actions to achieve real-world effects. The techniques of the present disclosure may be used, applied, and/or otherwise leveraged to generate structured rulesets, handle contextual queries, and/or the like, which may help in various downstream tasks. For instance, the knowledge graph, using some of the techniques of the present disclosure, may facilitate automated verification action that may trigger the performance of actions at a client device, such as the display, transmission, and/or the like of data reflective of a verification in accordance with a ruleset distilled from natural language documents. In some embodiments, a verification and/or ruleset associated therewith may trigger an alert of an approval, recommendation, and/or the like for a contextual scenario governed by a natural language document. The alert may be automatically communicated to a user associated with the contextual scenario.

In some examples, the computing tasks may include actions that may be based on a knowledge domain. A knowledge domain may include any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

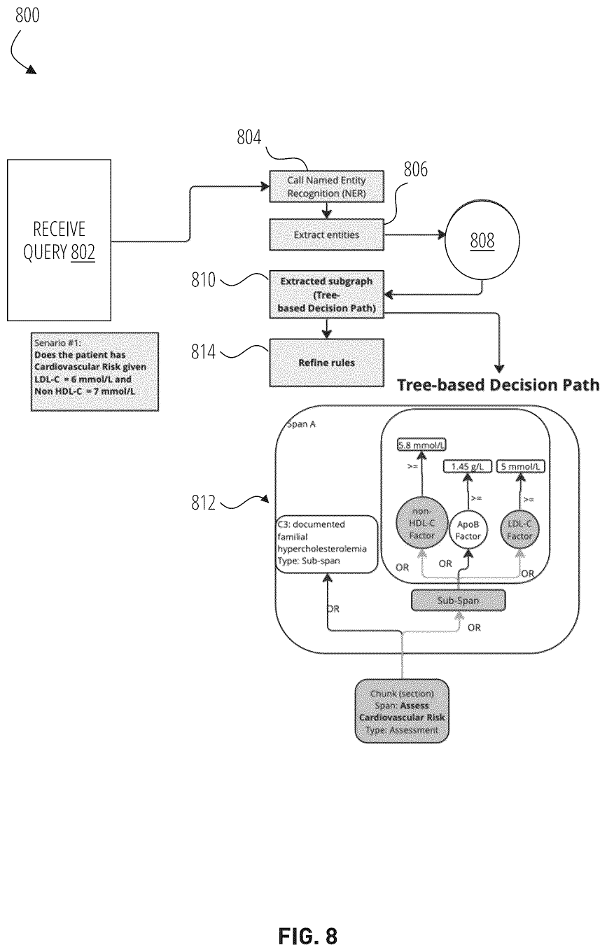

FIG. 8 is a flowchart diagram of an example process for leveraging a structure knowledge for improve query handling operations in accordance with some embodiments discussed herein. The flowchart depicts a generative text process 800 for improving the language modelling operations with respect to diverse use cases. The process 800 may be implemented by one or more computing devices, entities, and/or systems described herein. For example, via the various steps/operations of the process 800, the computing system 101 may leverage improved prompt engineering and quality assessment techniques to generate and evaluate generative text produced by an LLM. By doing so, the process 800 enables the generation of text that automatically adapts to a particular use case, while ensuring data quality in view of various controlling rules.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes, at step/operation 802, receive a query for contextual scenario. For example, the computing system 101 may receive a query including a text sequence. In some embodiment, a query is a data structure that describes a request to a knowledge graph. A query, for example, may include a textual prompt for a structured rule for a specific scenario. In response to the query, an inference may be performed over the knowledge graph to extract “tree-based rules” from the knowledge graph. In some examples, using a clinical example, the extracted rules may resemble patient questionnaires and/or the like. In some examples, a query is processed by extracting one or more sub-graph data objects from the knowledge graph given each question that maps to each criterion. The sub-graph data objects may be called Tree-based Decision Path (TPD). An inference may be performed on the knowledge graph, and rules may be validated by extracting the TDP subgraph by a depth-first search traversal algorithm.

In some embodiments, the process 800 includes, at step/operation 804, calling a NER model to process the query. For example, the computing system 101 may identify one or more data entity tokens from the text sequence. In some embodiments, the process 800 includes, at step/operation 806, extracting one or more of the data entity tokens from the query using the NER model.

In some embodiments, the process 800 includes, at step/operation 808, searching the knowledge graph using the extracted data entity tokens. For example, the computing system 101 may identify a section topic subgraph based on the one or more data entity tokens.

In some embodiments, the process 800 includes, at step/operation 810, extracting a subgraph from the knowledge graph that corresponds to the query. In some embodiments, the process 800 includes, at step/operation 812, identifying a tree-based decision path for the query based on the extracted subgraph.

In some embodiments, the process 800 includes, at step/operation 814, generating a structured rule from the extracted subgraph. For example, the computing system 101 may generate a structured rule set for the query based on the section topic subgraph.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising identifying, by one or more processors and using a natural language understanding (NLU) model, a plurality of data entity tokens from a target section of a multi-section natural language document; generating, by the one or more processors and using an embedding layer of a semantic chunking model, a text span embedding for a text span of the target section; generating, by the one or more processors and using a span attention layer of the semantic chunking model, a plurality of token-level span attention vectors for the plurality of data entity tokens based on the text span; generating, by the one or more processors, an attended span representation for the text span based on the text span embedding and the plurality of token-level span attention vectors; identifying, by the one or more processors and using a span classification layer of the semantic chunking model, an entity topic that corresponds to the text span based on the attended span representation; and responsive to an identification of the entity topic, generating, by the one or more processors, a subgraph data object for a knowledge graph using the text span.

Example 2. The computer-implemented method of example 1, wherein the target section is selected from a plurality of candidate sections of the multi-section natural language document and the computer-implemented method further comprises identifying a plurality of hierarchical text attributes of the multi-section natural language document based on a formatting of the multi-section natural language document; identifying the plurality of candidate sections based on the plurality of hierarchical text attributes; identifying, using the NLU model, a plurality of entity topics based on the plurality of candidate sections and the plurality of hierarchical text attributes; and identifying the plurality of data entity tokens based on the plurality of entity topics.

Example 3. The computer-implemented method of example 2, wherein generating the plurality of token-level span attention vectors comprises generating a plurality of section vectors from the multi-section natural language document based on the plurality of candidate sections, wherein the plurality of section vectors comprises a target vector for the target section that encodes one or more of the plurality of hierarchical text attributes associated with the target section; extracting a plurality of token vectors from the target vector based on the plurality of data entity tokens; and generating, using a transformer layer of the semantic chunking model, a token-level span attention vector for each of the plurality of token vectors.

Example 4. The computer-implemented method of example 3, wherein (i) the transformer layer is configured to output a plurality of token-level span embeddings and a document classification vector, (ii) the plurality of token-level span attention vectors is generated, using the span attention layer of the semantic chunking model, based on the plurality of token-level span embeddings, and (iii) the entity topic is identified based on the attended span representation and the document classification vector.

Example 5. The computer-implemented method of any of the preceding examples, wherein identifying the entity topic comprises identifying, using the NLU model, a plurality of entity topics from the multi-section natural language document; receiving a plurality of topic embeddings respectively corresponding to the plurality of entity topics; and identifying, using the span classification layer of the semantic chunking model, the entity topic based on a comparison between the plurality of topic embeddings and the attended span representation.

Example 6. The computer-implemented method of any of the preceding examples, wherein (i) the knowledge graph comprises a plurality of section topic subgraphs respectively corresponding to a plurality of section topic pairs from a plurality of a multi-section natural language documents, (ii) the subgraph data object comprises a span portion of a section topic subgraph of the plurality of section topic subgraphs that corresponds to the target section and the entity topic, and (iii) the section topic subgraph comprises one or more span portions respectively corresponding to one or more text spans of the target section.

Example 7. The computer-implemented method of example 6, further comprising receiving a query comprising a text sequence; identifying one or more data entity tokens from the text sequence; identifying the section topic subgraph based on the one or more data entity tokens; and generating a structured rule set for the query based on the section topic subgraph.

Example 8. The computer-implemented method of any of the preceding examples, wherein the text span comprises a subset of the plurality of data entity tokens and one or more entity relationship tokens associated with the subset of data entity tokens and generating the subgraph data object for the knowledge graph using the text span comprises generating one or more entity factor nodes respectively corresponding to the subset of data entity tokens, and generating one or more entity factor edges between the one or more entity factor nodes and respectively corresponding to the one or more entity relationship tokens.

Example 9. The computer-implemented method of example 8, further comprising removing an entity factor edge from the one or more entity factor edges based on one or more edge pruning criteria.

Example 10. The computer-implemented method of any of the preceding examples, further comprising generating, using the span classification layer of the semantic chunking model, a type classification prediction for the text span that identifies a mutually exclusive topic type from one or more mutually exclusive topic types associated with the entity topic; and in response to the type classification prediction satisfying a classification threshold, identifying the text span as a valid span and generating the subgraph data object for the mutually exclusive topic type.

Example 11. The computer-implemented method of any of the preceding examples, wherein identifying the plurality of data entity tokens from the target section of the multi-section natural language document comprises generating, using a supervised machine learning model, a plurality of sentence relevancy predictions for a plurality of section sentences of the target section; identifying one or more relevant sentences from the plurality of section sentences based on the plurality of sentence relevancy predictions; and identifying the plurality of data entity tokens from the one or more relevant sentences.

Example 12. A computing system comprising memory and one or more processors communicatively coupled to the memory, the one or more processors configured to identify, using a natural language understanding (NLU) model, a plurality of data entity tokens from a target section of a multi-section natural language document; generate, using an embedding layer of a semantic chunking model, a text span embedding for a text span of the target section; generate, using a span attention layer of the semantic chunking model, a plurality of token-level span attention vectors for the plurality of data entity tokens based on the text span; generate an attended span representation for the text span based on the text span embedding and the plurality of token-level span attention vectors; identify, using a span classification layer of the semantic chunking model, an entity topic that corresponds to the text span based on the attended span representation; and responsive to an identification of the entity topic, generate a subgraph data object for a knowledge graph using the text span.

Example 13. The computing system of example 12, wherein the target section is selected from a plurality of candidate sections of the multi-section natural language document and the computer-implemented method further comprises identifying a plurality of hierarchical text attributes of the multi-section natural language document based on a formatting of the multi-section natural language document; identifying the plurality of candidate sections based on the plurality of hierarchical text attributes; identifying, using the NLU model, a plurality of entity topics based on the plurality of candidate sections and the plurality of hierarchical text attributes; and identifying the plurality of data entity tokens based on the plurality of entity topics.

Example 14. The computing system of example 13, wherein generating the plurality of token-level span attention vectors comprises generating a plurality of section vectors from the multi-section natural language document based on the plurality of candidate sections, wherein the plurality of section vectors comprises a target vector for the target section that encodes one or more of the plurality of hierarchical text attributes associated with the target section; extracting a plurality of token vectors from the target vector based on the plurality of data entity tokens; and generating, using a transformer layer of the semantic chunking model, a token-level span attention vector for each of the plurality of token vectors.

Example 15. The computing system of example 14, wherein (i) the transformer layer is configured to output a plurality of token-level span embeddings and a document classification vector, (ii) the plurality of token-level span attention vectors is generated, using the span attention layer of the semantic chunking model, based on the plurality of token-level span embeddings, and (iii) the entity topic is identified based on the attended span representation and the document classification vector.

Example 16. The computing system of any of examples 12 through 15, wherein identifying the entity topic comprises identifying, using the NLU model, a plurality of entity topics from the multi-section natural language document; receiving a plurality of topic embeddings respectively corresponding to the plurality of entity topics; and identifying, using the span classification layer of the semantic chunking model, the entity topic based on a comparison between the plurality of topic embeddings and the attended span representation.

Example 17. The computing system of any of examples 12 through 16, wherein (i) the knowledge graph comprises a plurality of section topic subgraphs respectively corresponding to a plurality of section topic pairs from a plurality of a multi-section natural language documents, (ii) the subgraph data object comprises a span portion of a section topic subgraph of the plurality of section topic subgraphs that corresponds to the target section and the entity topic, and (iii) the section topic subgraph comprises one or more span portions respectively corresponding to one or more text spans of the target section.

Example 18. The computing system of example 17, further comprising receiving a query comprising a text sequence; identifying one or more data entity tokens from the text sequence; identifying the section topic subgraph based on the one or more data entity tokens; and generating a structured rule set for the query based on the section topic subgraph.

Example 19. One or more non-transitory computer-readable storage media including instructions that, when executed by one or more processors, cause the one or more processors to identify, using a natural language understanding (NLU) model, a plurality of data entity tokens from a target section of a multi-section natural language document; generate, using an embedding layer of a semantic chunking model, a text span embedding for a text span of the target section; generate, using a span attention layer of the semantic chunking model, a plurality of token-level span attention vectors for the plurality of data entity tokens based on the text span; generate an attended span representation for the text span based on the text span embedding and the plurality of token-level span attention vectors; identify, using a span classification layer of the semantic chunking model, an entity topic that corresponds to the text span based on the attended span representation; and responsive to an identification of the entity topic, generate a subgraph data object for a knowledge graph using the text span.

Example 20. The one or more non-transitory computer-readable storage media of example 19, wherein identifying the plurality of data entity tokens from the target section of the multi-section natural language document comprises generating, using a supervised machine learning model, a plurality of sentence relevancy predictions for a plurality of section sentences of the target section; identifying one or more relevant sentences from the plurality of section sentences based on the plurality of sentence relevancy predictions; and identifying the plurality of data entity tokens from the one or more relevant sentences.

Example 21. The computer-implemented method of example 1, wherein the method further comprises training the semantic chunking model.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computing system of example 12, wherein the one or more processors are further configured to train the semantic chunking model.

Example 25. The computing system of example 24, wherein the one or more processors are included in a first computing entity; and the semantic chunking model is trained by one or more other processors included in a second computing entity.

Example 26. The one or more non-transitory computer-readable storage media of example 19, wherein the instructions further cause the one or more processors to train the semantic chunking model.

Example 27. The one or more non-transitory computer-readable storage media of example 26, wherein the one or more processors are included in a first computing entity; and the semantic chunking model are trained by one or more other processors included in a second computing entity.

1. A computer-implemented method comprising:
identifying, by one or more processors and using a natural language understanding (NLU) model, a plurality of data entity tokens from a target section of a multi-section natural language document;
generating, by the one or more processors and using an embedding layer of a semantic chunking model, a text span embedding for a text span of the target section;
generating, by the one or more processors and using a span attention layer of the semantic chunking model, a plurality of token-level span attention vectors for the plurality of data entity tokens based on the text span;
generating, by the one or more processors, an attended span representation for the text span based on the text span embedding and the plurality of token-level span attention vectors;
identifying, by the one or more processors and using a span classification layer of the semantic chunking model, an entity topic that corresponds to the text span based on the attended span representation; and
responsive to an identification of the entity topic, generating, by the one or more processors, a subgraph data object for a knowledge graph using the text span.

2. The computer-implemented method of claim 1, wherein the target section is selected from a plurality of candidate sections of the multi-section natural language document and the computer-implemented method further comprises:
identifying a plurality of hierarchical text attributes of the multi-section natural language document based on a formatting of the multi-section natural language document;
identifying the plurality of candidate sections based on the plurality of hierarchical text attributes;
identifying, using the NLU model, a plurality of entity topics based on the plurality of candidate sections and the plurality of hierarchical text attributes; and
identifying the plurality of data entity tokens based on the plurality of entity topics.

3. The computer-implemented method of claim 2, wherein generating the plurality of token-level span attention vectors comprises:
generating a plurality of section vectors from the multi-section natural language document based on the plurality of candidate sections, wherein the plurality of section vectors comprises a target vector for the target section that encodes one or more of the plurality of hierarchical text attributes associated with the target section;
extracting a plurality of token vectors from the target vector based on the plurality of data entity tokens; and
generating, using a transformer layer of the semantic chunking model, a token-level span attention vector for each of the plurality of token vectors.

4. The computer-implemented method of claim 3, wherein:
(i) the transformer layer is configured to output a plurality of token-level span embeddings and a document classification vector,
(ii) the plurality of token-level span attention vectors is generated, using the span attention layer of the semantic chunking model, based on the plurality of token-level span embeddings, and
(iii) the entity topic is identified based on the attended span representation and the document classification vector.

5. The computer-implemented method of claim 1, wherein identifying the entity topic comprises:
identifying, using the NLU model, a plurality of entity topics from the multi-section natural language document;
receiving a plurality of topic embeddings respectively corresponding to the plurality of entity topics; and
identifying, using the span classification layer of the semantic chunking model, the entity topic based on a comparison between the plurality of topic embeddings and the attended span representation.

6. The computer-implemented method of claim 1, wherein:
(i) the knowledge graph comprises a plurality of section topic subgraphs respectively corresponding to a plurality of section topic pairs from a plurality of a multi-section natural language documents,
(ii) the subgraph data object comprises a span portion of a section topic subgraph of the plurality of section topic subgraphs that corresponds to the target section and the entity topic, and
(iii) the section topic subgraph comprises one or more span portions respectively corresponding to one or more text spans of the target section.

7. The computer-implemented method of claim 6, further comprising:
receiving a query comprising a text sequence;
identifying one or more data entity tokens from the text sequence;
identifying the section topic subgraph based on the one or more data entity tokens; and
generating a structured rule set for the query based on the section topic subgraph.

8. The computer-implemented method of claim 1, wherein the text span comprises a subset of the plurality of data entity tokens and one or more entity relationship tokens associated with the subset of data entity tokens and generating the subgraph data object for the knowledge graph using the text span comprises:
generating one or more entity factor nodes respectively corresponding to the subset of data entity tokens, and
generating one or more entity factor edges between the one or more entity factor nodes and respectively corresponding to the one or more entity relationship tokens.

9. The computer-implemented method of claim 8, further comprising removing an entity factor edge from the one or more entity factor edges based on one or more edge pruning criteria.

10. The computer-implemented method of claim 1, further comprising:
generating, using the span classification layer of the semantic chunking model, a type classification prediction for the text span that identifies a mutually exclusive topic type from one or more mutually exclusive topic types associated with the entity topic; and
in response to the type classification prediction satisfying a classification threshold, identifying the text span as a valid span, and generating the subgraph data object for the mutually exclusive topic type.

11. The computer-implemented method of claim 1, wherein identifying the plurality of data entity tokens from the target section of the multi-section natural language document comprises:
generating, using a supervised machine learning model, a plurality of sentence relevancy predictions for a plurality of section sentences of the target section;
identifying one or more relevant sentences from the plurality of section sentences based on the plurality of sentence relevancy predictions; and
identifying the plurality of data entity tokens from the one or more relevant sentences.

12. A computing system comprising memory and one or more processors communicatively coupled to the memory, the one or more processors configured to:
identify, using a natural language understanding (NLU) model, a plurality of data entity tokens from a target section of a multi-section natural language document;
generate, using an embedding layer of a semantic chunking model, a text span embedding for a text span of the target section;
generate, using a span attention layer of the semantic chunking model, a plurality of token-level span attention vectors for the plurality of data entity tokens based on the text span;
generate an attended span representation for the text span based on the text span embedding and the plurality of token-level span attention vectors;
identify, using a span classification layer of the semantic chunking model, an entity topic that corresponds to the text span based on the attended span representation; and
responsive to an identification of the entity topic, generate a subgraph data object for a knowledge graph using the text span.

13. The computing system of claim 12, wherein the target section is selected from a plurality of candidate sections of the multi-section natural language document and the computer-implemented method further comprises:
identifying a plurality of hierarchical text attributes of the multi-section natural language document based on a formatting of the multi-section natural language document;
identifying the plurality of candidate sections based on the plurality of hierarchical text attributes;
identifying, using the NLU model, a plurality of entity topics based on the plurality of candidate sections and the plurality of hierarchical text attributes; and
identifying the plurality of data entity tokens based on the plurality of entity topics.

14. The computing system of claim 13, wherein generating the plurality of token-level span attention vectors comprises:
generating a plurality of section vectors from the multi-section natural language document based on the plurality of candidate sections, wherein the plurality of section vectors comprises a target vector for the target section that encodes one or more of the plurality of hierarchical text attributes associated with the target section;
extracting a plurality of token vectors from the target vector based on the plurality of data entity tokens; and
generating, using a transformer layer of the semantic chunking model, a token-level span attention vector for each of the plurality of token vectors.

15. The computing system of claim 14, wherein:
(i) the transformer layer is configured to output a plurality of token-level span embeddings and a document classification vector,
(ii) the plurality of token-level span attention vectors is generated, using the span attention layer of the semantic chunking model, based on the plurality of token-level span embeddings, and
(iii) the entity topic is identified based on the attended span representation and the document classification vector.

16. The computing system of claim 12, wherein identifying the entity topic comprises:
identifying, using the NLU model, a plurality of entity topics from the multi-section natural language document;
receiving a plurality of topic embeddings respectively corresponding to the plurality of entity topics; and
identifying, using the span classification layer of the semantic chunking model, the entity topic based on a comparison between the plurality of topic embeddings and the attended span representation.

17. The computing system of claim 12, wherein:
(i) the knowledge graph comprises a plurality of section topic subgraphs respectively corresponding to a plurality of section topic pairs from a plurality of a multi-section natural language documents,
(ii) the subgraph data object comprises a span portion of a section topic subgraph of the plurality of section topic subgraphs that corresponds to the target section and the entity topic, and
(iii) the section topic subgraph comprises one or more span portions respectively corresponding to one or more text spans of the target section.

18. The computing system of claim 17, further comprising:
receiving a query comprising a text sequence;
identifying one or more data entity tokens from the text sequence;
identifying the section topic subgraph based on the one or more data entity tokens; and
generating a structured rule set for the query based on the section topic subgraph.

19. One or more non-transitory computer-readable storage media including instructions that, when executed by one or more processors, cause the one or more processors to:
identify, using a natural language understanding (NLU) model, a plurality of data entity tokens from a target section of a multi-section natural language document;
generate, using an embedding layer of a semantic chunking model, a text span embedding for a text span of the target section;
generate, using a span attention layer of the semantic chunking model, a plurality of token-level span attention vectors for the plurality of data entity tokens based on the text span;
generate an attended span representation for the text span based on the text span embedding and the plurality of token-level span attention vectors;
identify, using a span classification layer of the semantic chunking model, an entity topic that corresponds to the text span based on the attended span representation; and
responsive to an identification of the entity topic, generate a subgraph data object for a knowledge graph using the text span.

20. The one or more non-transitory computer-readable storage media of claim 19, wherein identifying the plurality of data entity tokens from the target section of the multi-section natural language document comprises:
generating, using a supervised machine learning model, a plurality of sentence relevancy predictions for a plurality of section sentences of the target section;
identifying one or more relevant sentences from the plurality of section sentences based on the plurality of sentence relevancy predictions; and
identifying the plurality of data entity tokens from the one or more relevant sentences.
